(19) United States
(12) Patent Application Publication
(10) Pub. No.: US 2015/0092811 A1
(43) Pub. Date: Apr. 2, 2015

(54) Nanoparticles-Based Taggant Systems and Methods

(71) Applicant: Worcester Polytechnic Institute, Worcester, MA (US)

(72) Inventor: Ming Su, Chestnut Hill, MA (US)

(21) Appl. No.: 14/495,244

(22) Filed: Sep. 24, 2014

Related U.S. Application Data
(60) Provisional application No. 61/881,668, filed on Sep. 24, 2013.

(51) Int. Cl. G01K 11/06; G06K 19/06; G01K 17/00

(52) U.S. Cl. CPC G01K 11/06; G01K 17/00; G06K 19/06; B82Y 35/00
USPC 374/31; 977/900

(57) ABSTRACT

Coding systems may include an object and a taggant linked to the object, the taggant comprising one or more types of phase change nanoparticles, each type of phase change nanoparticles having a phase change temperature different from a phase change temperature of other types of phase change nanoparticles, wherein, when the taggant is thermally scanned, different phase change temperatures result in one or more predefined melting peaks forming a code that represents information particular to the object.

### RELATED APPLICATIONS

This application claims the benefit of and priority to U.S. Provisional Application No. 61/881,668, filed on Sep. 24, 2013, which is incorporated herein by reference in its entirety.

### STATEMENT OF GOVERNMENT SUPPORT

This invention was made with Government Support under Grant Number 105599 awarded by the National Science Foundation, and Grant Number 2012-DN-BX-K021 awarded by the United States Department of Justice. The Government has certain rights in the invention.

### FIELD

The present disclosure relates to nanoparticles-based taggant systems and methods, and more particularly to taggant systems employing nanoparticles with a phase change material and methods of making such taggants.

### BACKGROUND

Covert or invisible taggants can be used to enhance capacity of law enforcement, security and intelligence agencies by identifying criminal/terrorists, authenticating documents, facilitating tamper detection, and tracing-tracking objects, thereby providing high impacts and revolutionary improvement to intelligence-gathering and surveillance capabilities. Many government-issued documents such as identity cards, passports, certificates, tax stamps, driver licenses and currency notes and valuable commercial products such as drugs, guitar strings among many others are constant targets of counterfeit, but there has no adequate way to certificate their origins (watermarking) due to huge number of documents.

Existing identification techniques (serial number, optical barcode, intaglio feature, microscale features and radio frequency devices) have been used widely in overt labeling, they are not appropriate for covert operations due to large size, visibility, high cost, and possibility of losing integrity. Chemical and fluorescent taggants are low-cost and easy-to-read, but have low level of multiplicity (small code space), low sensitivity and secureness and are only suited for simple authentication rather than serialization application; even under such condition, they are subject to be counterfeited due to their ubiquitous natures. Glass and plastic microbeads have been added in explosive as taggants; after explosion, the microbeads can be collected from debris and tested to determine origin of explosive. But microbeads lack sensitivity, secureness, and covertness. Indeed, it is possible to distinguish the relatively large particles (whose diameters exceed 100 μm) by eye. Microfibers or chemicals can be embedded in objects (paper documents) and used as intangible taggants, where fiber morphology can be distinguished with microscope, or chemicals can be identified, but microfibers are too large to offer large coding capacity, and their morphological signature cannot be readout directly. In addition, chemical analysis has to be done in a comprehensive characterization facility.

Accordingly, there is an unmet need to develop new covert and non-covert taggants that can be used robustly by industries using taggant systems, methods or other identification related applications.

### SUMMARY

The present disclosure provides improved nanoparticles-based covert taggant systems and methods for producing such systems that address the shortcoming of the presently used systems and methods.

In some aspects, there is provided a coding system that includes an object and a taggant linked to the object, the taggant comprising one or more types of phase change nanoparticles, each type of phase change nanoparticles having a phase change temperature different from a phase change temperature of other types of phase change nanoparticles, wherein, when the taggant is thermally scanned, different phase change temperatures result in one or more predefined melting peaks forming a code that represents information particular to the object. In some embodiments, the system further comprising: a melting peak measuring device configured for receiving a sample of the object, and reading the code particular to the sample of the object and communicating the code to a processor, the processor being programmed compare the code to a predetermined set of codes indicative of no identification or positive identification; and indicating an identification, if the code particular to the sample of the object is in the predetermined set of identifiable codes.

In some aspects, there is provided a method for identifying an object that includes thermally scanning a sample of an object including a taggant, the taggant comprising a plurality of phase change nanoparticles of one or more types having different phase change temperatures; generating a thermal readout of the sample of the object based on the one or more types of the nanoparticles of the taggant; and identifying the object by matching the thermal readout of the sample of the object with a predetermined thermal readout in a library of thermal readouts.

In some aspects, there is provided a method of tagging an object that includes linking to an object a taggant comprising a plurality of phase change nanoparticles of one or more types having different phase change melting peak temperatures.

### DESCRIPTION OF THE DRAWINGS

The presently disclosed embodiments can be further explained with reference to the attached drawings. The drawings shown are not necessarily to scale, with emphasis instead generally being placed upon illustrating the principles of the presently disclosed embodiments.

FIG. 1A and FIG. 1B illustrate two taggants of the present disclosure including different combination of phase change materials and their thermal readouts;

FIG. 2A illustrates a tertiary phase diagram for eutectic alloys;

FIG. 2B illustrates the Pascal's triangle;

FIG. 3A is a scanning electron microscope (SEM) image of bismuth nanoparticles;

FIG. 3B is a TEM image of bismuth nanoparticles;

FIG. 3C is DSC curve of bismuth nanoparticles;

FIG. 3D illustrates a thermal ramp rate dependent peak width of nanoparticles made of various materials;

FIG. 3E is a TEM image of iron oxide nanoparticles;

FIG. 3F illustrates emission spectra of three different sizes of CdSe/ZnS quantum dots;

FIG. 4A shows a TEM image of bismuth nanoparticles encapsulated in silica shell before annealing;

FIG. 4B shows a TEM image of bismuth nanoparticles encapsulated in silica shell after annealing at a high temperature;

FIG. 5A is SEM image of silica microspheres containing indium and tin nanoparticles;

FIG. 5B is EDX spectrum of silica microspheres containing indium and tin nanoparticles;

FIG. 5C illustrates DSC curves of various types of silica microspheres, where each melting peak is denoted as 1 or 0 depending on whether there is detectable heat influx or not;

FIG. 6A illustrates how the phase change particles can easily encode a drug at the point of formulation. Decoding process can easily be achieved by performing a quick thermal scan;

FIG. 6B is a SEM image of synthesized 12-HDA particles;

FIG. 6C is a FTIR spectra that confirms the chemical structures of bulk PCM materials are still preserved in the synthesized particles;

FIG. 6D is a photograph of acetaminophen after encoded with phase change particles. It is invisible to naked eye that the drug has been mixed with PCM particles. Suspension of stearic acid particles in water is shown in set;

FIG. 6E is cytotoxicity study of the drug and phase change particles;

FIG. 7A presents a DSC curve of synthesized nanoparticles of palmitic acid (PA).

FIG. 7B presents a DSC curve of synthesized nanoparticles of stearic acid (SA).

FIG. 7C presents a phase diagram of eutectic compound of PA and SA.

FIG. 7D presents a DSC curve of the eutectic particles shown in FIG. 7C;

FIG. 8A presents DSC curves show decoding time of stearic particles encoded in acetaminophen at different scan rates;

FIG. 8B is a plot showing the widths of the melting peaks as a function of ramp rates;

FIG. 8C is a panel of DSC curves collected from 16 different mixtures of phase change particles in Acetaminophen. The temperature range from left to right is from 50 to 140° C.;

FIG. 9 illustrates multilayer taggants with enhanced labeling security; this taggant contains three layers, namely, optical taggant, thermal taggant, and microtaggants;

FIG. 10 illustrates a DSC curve of a sample of Bi—Pb—Sn alloy with size of approximately 50 micrometer long and approximately 30 micrometer wide without a microsphere shell, which was cut from a big block of alloy;

FIG. 11 illustrates a DSC curve of a sample of stearic acid with size of approximately 40 micrometer long and approximately 20 micrometer wide without a shell, which was cut from a centimeter scale block;

FIG. 12 illustrates a DSC curve of a sample of Bi—Pb alloy without a shell;

FIG. 13A illustrates the calculated phase diagram of lead-tin alloy, and the DSC curve of lead-tin eutectic alloy (inset figure);

FIG. 13 B illustrates the calculated and measured melting points of ten alloys;

FIG. 13C illustrates the melting temperatures and latent heats of fusion of 50 metals and alloys;

FIG. 14A is a calculated phase diagram for Sn63Pb37 alloy;

FIG. 14B shows latent heat of nanoparticles in the order of melting temperature from low to high;

FIG. 14C shows melting temperatures of nanoparticles from calculation and measurement;

FIG. 14D shows latent heat of fusion of nanoparticles from calculation and measurement;

FIG. 15A is a TEM image of Sn₆₃Pb₃₇ eutectic alloy nanoparticles;

FIG. 15B is a size distribution diagram of Sn₆₃Pb₃₇ eutectic alloy nanoparticles;

FIG. 15C presents DSC results of 8 types of nanoparticles;

FIG. 15D XRF result of Sn₆₃Pb₃₇ eutectic alloy nanoparticles;

FIG. 16A is SEM image of nail polish fibers obtained from electric printing;

FIG. 16B is a fluorescent image of stamped pattern;

FIG. 16C presents DSC results of 8 particles in nail polish, and nail polish itself;

FIG. 16D presents XRF results of In and Pb—Bi eutectic alloy nanoparticles in nail polish matrix;

FIG. 17A and FIG. 17B present optical and fluorescent images, respectively, of characters written with inks of nanoparticles suspended in PUS matrix;

FIG. 17C and FIG. 17D present optical and fluorescent images, respectively, of micropatterns formed using nanoparticle-PUS composite;

FIG. 17E and FIG. 17F present DSC results of PUS and nanoparticle-PUS composition, respectively;

FIG. 18A and FIG. 18B present optical and fluorescent images, respectively, of macroscale pattern generated by stamping a nanoparticle-PVA composite;

FIG. 18C and FIG. 18D present optical and fluorescent images, respectively, of microscale pattern made by stamping nanoparticle-PVA composite;

FIG. 18E and FIG. 18F present DSC results of PVA alone and nanoparticle-PVA composite, respectively;

FIGS. 19A, 19B and 19D provide DSC scans for indium nanoparticles, tin nanoparticles, and indium-tin eutectic nanoparticles, respectively;

FIG. 19C is a graph of melting temperature as a function of composition for indium-tin eutectic alloy;

FIG. 19E illustrates an embodiment where the taggants of the present disclosure may be incorporated into explosives to allow tracing of explosives;

FIG. 20A illustrates five potential thermal readouts for explosives;

FIG. 20B is a graph showing relation between melting point and ramp rate;

FIG. 20C is graph showing relation between peak area and ramp rate;

FIG. 20D is a graph showing relation between peak width and ramp rate;

FIG. 21A illustrates a graph of heat flow as a function of mass of the sample;

FIG. 21B illustrates relation between the intensity of a melting peak (aka heat flow) and heating rate;

FIG. 21C illustrates the decoding time of less than 10 minutes for a thermal run from 30° C. to 300° C. with ramp rate of 30° C./min; and

FIG. 22 illustrates exemplary thermal readouts.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure provides a taggant system comprising a panel of phase change nanoparticles that have sharp and discrete melting peaks. The nanoparticles can be directly used or in some instants be encapsulated in microspheres, such as silica or polymer microspheres. A new signal transduction mechanism (i.e., thermal readout) can be used to readout taggants by detecting phase changes of the nanoparticles. In some embodiments, the melting temperature and fusion enthalpy of each type of nanoparticles can be derived by using differential scanning calorimetry (DSC). In some embodiments, magnetic or semiconductor nanoparticles may also be added into the mixture of phase change nanoparticles, or encapsulated in microspheres together with phase change nanoparticles, forming multi-functional taggants that can be used to achieve multi-layered authentication.

In some embodiments, the present disclosure provides a phase change nanoparticle coding system that includes an object and a taggant linked to the object, the taggant comprising one or more types of phase change nanoparticles, each type of phase change nanoparticles having a predefined phase change temperature different from a phase change temperature of other types of phase change nanoparticles, wherein, when the taggant is thermally scanned, different phase change temperatures of the phase change nanoparticles result in one or more predefined melting peaks forming a code that represents information particular to the object. The taggant may be implanted into the object or contained by the object. In some embodiments, the taggant may be disposed on the surface of the object or otherwise connected to the surface of the object. Other methods of linking the taggant to the object may also be used.

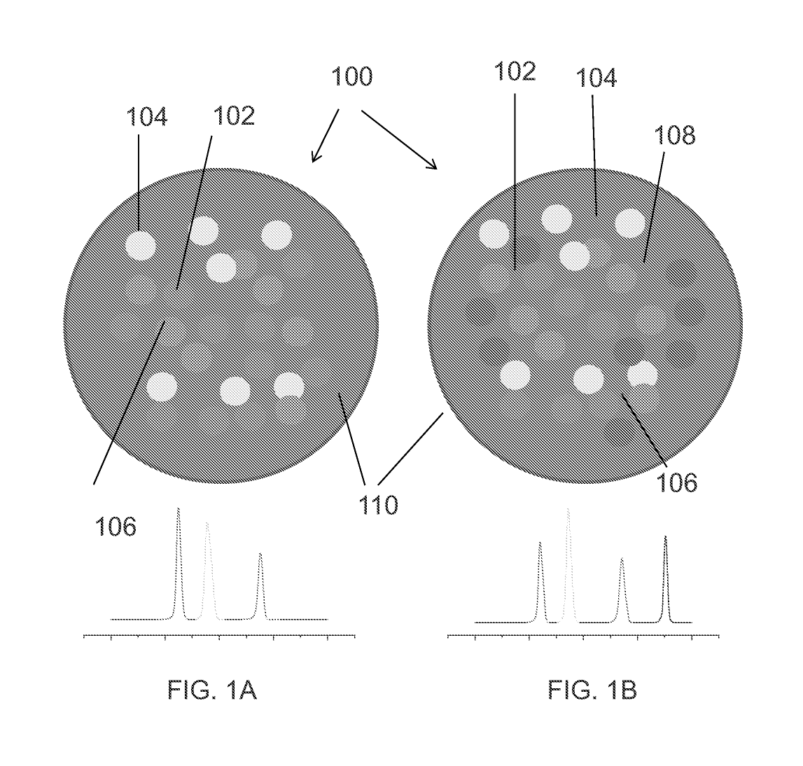

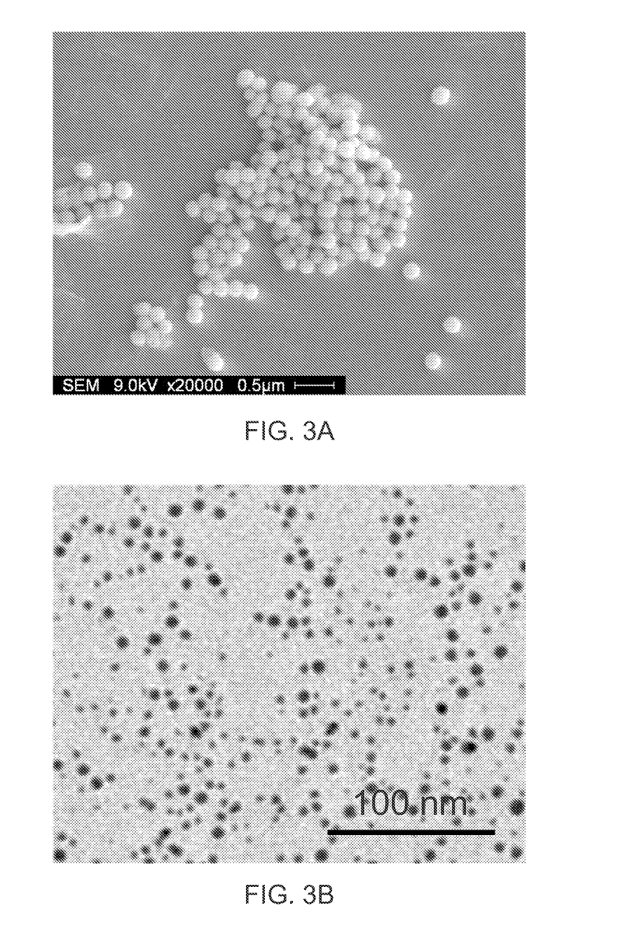

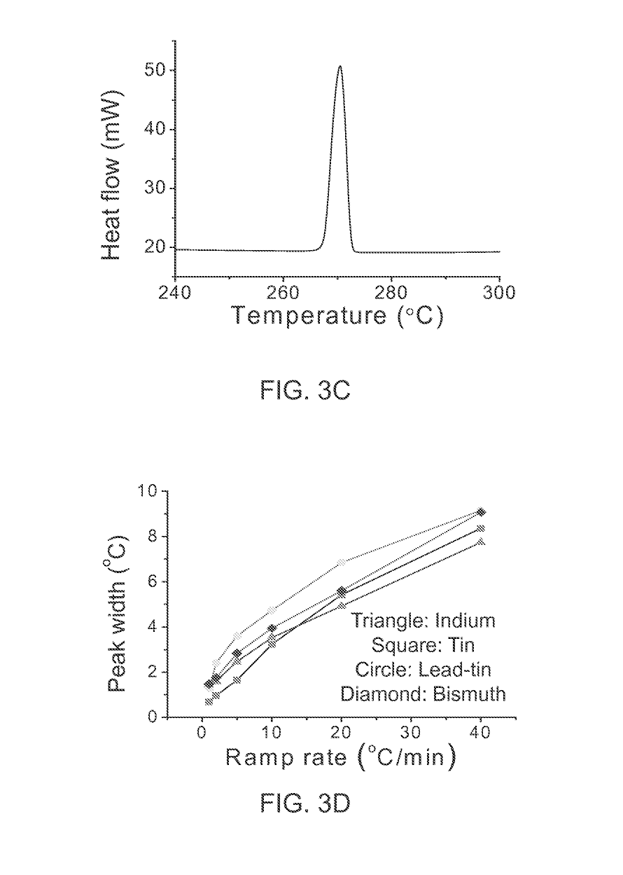

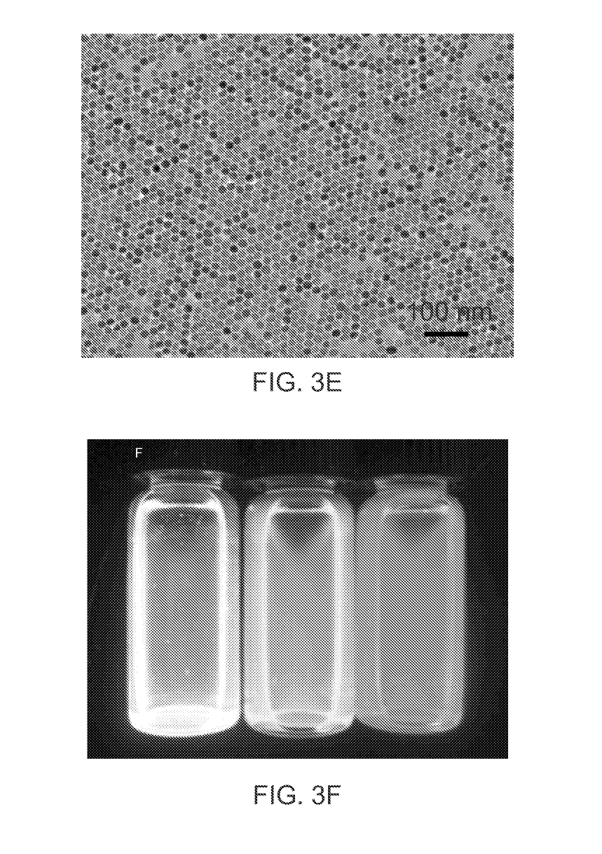

In reference to FIG. 1A and FIG. 1B, a taggant 100 of the present disclosure may include a plurality of one or more types of phase change nanoparticles 102-108. In some embodiments, as shown in FIG. 1A and FIG. 1B, they may be encapsulated into a casing 110, such as a microsphere or any other shape or any other size. However, many embodiments of the phase change nanoparticles devices, methods and systems incorporated herein are not encapsulated in a microsphere, as shown, for example, in FIG. 3A.

Phase change materials have unique thermophysical properties. Once a state change occurs (e.g., solid changes to a liquid), heat is released or absorbed, and such a thermal change can produce a detectable, thermal signal that can be measured. In some embodiments, different types of the phase change nanoparticles 102-108 change phase at different temperatures. In this manner, each taggant 100 can be designed to have a unique thermal readout, depending on the type of phase change nanoparticles included into the taggant 100, so the taggant 100 may be easily identified by a thermal scan.

It may be possible for the size of the phase change particles to range from 20 nm up to micrometers, or even millimeters. For example, for non-covert applications, the size of phase change particles may be over centimeters, or even have a size of 1 cm cubic or more.

The types of phase change material can include materials that can undergo any of solid-to-solid, a solid-to-liquid, a solid-to-gas, or a liquid-to-gas phase changes. In some embodiments, the phase change material may be a solid-to-liquid phase change material. In some embodiments, the phase change material may be a reversible phase change material so the taggant 100 can be heated and cooled multiple times in the same detection analysis and/or used multiple times in different detection analyses. The phase change material can be any solids such as organic, inorganic, a eutectic alloy, an alloy, or a combination thereof. In various embodiments, the phase change material can be solids, for example metals and eutectic alloys, organic solids such as paraffin waxes, and salts and salt mixtures. Other materials that can change phases such as liquid crystals, proteins/DNAs, etc can also be used. Suitable phase change materials include, but are not limited to, indium, tin, lead, bismuth, gold, silver, salt (NaCl, etc), paraffin wax, and other organic materials can also be used. Eutectic alloys that can be used include Ag (silver), Al (aluminum), Au (gold), Bi (bismuth), Cu (copper), In (indium), Ni (nickel), Pb (lead), Sb (antimony), Sn (tin), Zn (zinc), and other elements. Alloys that can be used include binary, ternary, or other higher ordered alloys of the elements that can form alloys. Organic materials that can be used include paraffin wax, organic solid, organic acids, and the like. Although some specific phase change materials are described, it is contemplated that other phase change materials can be used as long as they act in a manner consistent with the teachings of the present disclosure.

As noted above, the phase change nanoparticles may offer unique thermal properties. For example, regarding the use of metals or alloys, during melting, metals absorb heat without temperature rise based on Gibbs phase rule. If the dimension of metal is small enough, the melting time will be negligible due to high thermal conductivity of metal. Most metals form eutectic alloys that go directly from solid to liquid phases without pasty stage, and can be treated as pure metals. Metals and eutectic alloys have sharp melting peaks in DSC. The melting temperature is typically dependent on the atomic number (for metal) and composition (for alloy), providing that the size of material is larger than the thermodynamic threshold size (20 nm), below which surface atoms will contribute more and cause reduction of melting temperature. The fusion enthalpy of metal/alloy depends on the mass, composition and the latent heat of fusion. DSC is often used to derive melting temperature and fusion enthalpy of a solid sample. The covert barcode may include a variety of eutectic alloys of low cost metals, and prepared their nanoparticles (diameter of ˜50 nm) using colloidal methods.

The amount of the phase change material in the taggant 100 may depend on detection sensitivity of thermal analysis equipment. In some embodiments, when the phase material is encapsulated in a casing 110, the amount of the phase change material in the casing can also depend upon an inner volume of the casing 110, as well as the volumetric expansion characteristics of the phase change material.

The melting point of the phase change material depends upon the specific phase change material. In some embodiments, the phase change or melting point of the phase change nanoparticles can be about 50 to about 1000° C. In some embodiments, the phase change point may be about 100 to about 700° C. In some embodiments, the separation between melting points of different types of the phase change nanoparticles can be less than about 2° C. In some embodiments, the separation between melting points of different types of the phase change nanoparticles can be between about 0.5° C. and about 1° C.

In some embodiments, phase change nanoparticles of the present disclosure can be made of aluminum, bismuth, cadmium, copper, gadillium, indium, lead, magnesium, palladium, and silver, which can form 10 types of metal nanoparticles, 45 type of binary alloy nanoparticles, 120 types of ternary eutectic alloy nanoparticles, 210 types of quaternary eutectic alloy nanoparticles, and so on. The total number of metals and eutectic alloys can reach 1,023. Nanoparticles of these metals and eutectic alloys may have sharp and discrete melting peaks that can be resolved by DSC with high peak resolution (0.01° C.).

In some embodiments, phase change nanoparticles of the present disclosure can be made of various combinations including one or more of bismuth, copper, indium, lead, magnesium, and silver, which can form a total of 63 different types of nanoparticles. The compositions of binary eutectic alloys can be derived from available phase diagrams. In order to determine the compositions of ternary alloys and other high order eutectic alloys, Computer Coupling of Phase Diagrams and Thermochemistry (CALPHAD) can be used, where parameters used to derive total free energies can be obtained by fitting binary phase diagrams. These theoretical calculations can be carried out using commercial software (Pandat). In some embodiments, compositions may be selected having a melting temperature distributed evenly over the whole temperature range (100-600° C.), and the latent heats of fusion of alloys are as large as possible (to offer higher thermal detection sensitivity).

In some embodiments, the shell of the casing 110 can be composed of a material having a melting temperature higher than the highest phase change temperatures of the nanoparticles inside that shell. Suitable materials include, but are not limited to, silica, alumina, titania, polymer, an oxide of the phase change material (as long as the oxide has a high enough melting point to be used in the particular embodiments), or a combination thereof. In some embodiments, the outer structure can be made by thermo-decomposition of precursors of the phase-change material, polymers, and/or surfactants. In an embodiment, the outer structure is silica. The outer structure can have a thickness of about 2 nm to 200 nm or about 5 nm to 100 nm. The outer structure can have a diameter of about 1 nm to 5000 nm, about 1 nm to 1000 nm, about 10 nm to 1000 nm, about 10 nm to 500 nm, or about 10 to 250 nm. In some embodiments, the nanoparticles can be embedded into an appropriate matrix (with any thickness, any shape, or any composition). In some embodiments, the material for the casing may be selected to contribute to the thermal readout of the taggant 100. In some embodiments, the phase change nanoparticles can be added directly into or attached onto object.

In general, this type of barcode, as noted above, can be used for most any application with combinations of phase change materials. For example, there is an equation showing that certain parameters are connected. The sensitivity, multiplicity and analysis time are determined by fusion enthalpy (ΔH), peak width at half maximum (w), and thermal ramp rate (β), respectively. The sensitivity, multiplicity and analysis time are related to each other as indicated in the following peak width equation. The width of melting peak can be derived from Gray's model using (i.e. Eq. 1):

$$w = {RC}_{s} [ \sqrt{1 + \frac{2 Δ H}{{RC}_{s}^{2} \cdot β}} - 1 + ln 100 ] \cdot β \qquad EQ \text{:} 1$$

where R is the thermal resistance of whole system and Cₛ is the heat capacity of sample.

By way of a non-limiting example, the following parameters may be used when designing the taggants of the present disclosure.

Peak Width of Solid-Liquid Phase Change:

By using a normal DSC, the peak width at half maximum of metallic nanoparticles can be less than 1° C. (0.6° C. at ramp rate of 1° C./minute). If the thermal scan range is from 100 to 700° C., the maximum number of melting peaks that could be resolved can reach 1,000 according to Rayleigh's criterion on spectral resolution, which means that ˜1,000 different types of nanoparticles can be detected in one thermal scan.

Nanoparticle of Eutectic Alloy:

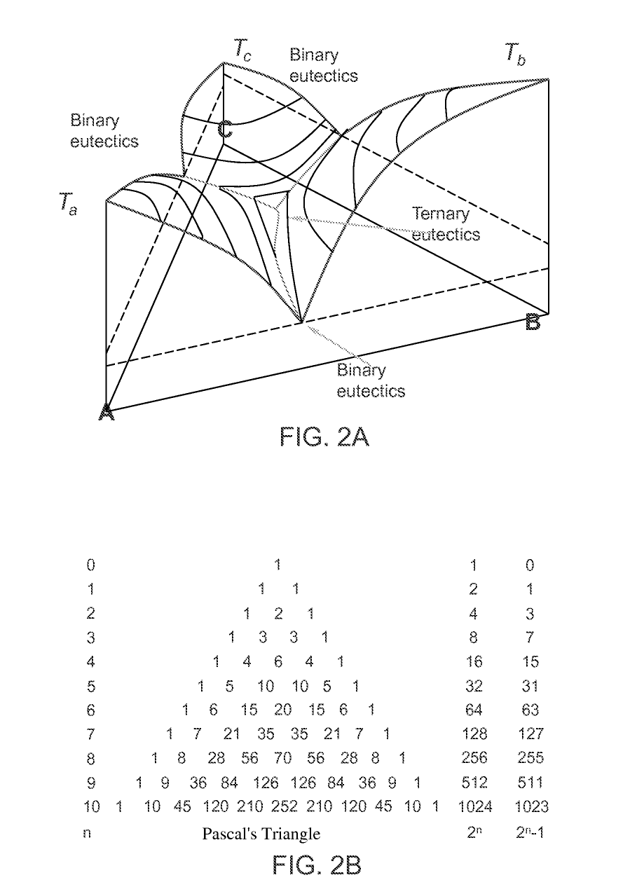

Alloy nanoparticles with eutectic compositions have single sharp melting peaks, where the melting temperatures are determined by compositions providing that their sizes are larger than critical sizes (20 nm). According to combination rule, if any two of three metals can form binary eutectic alloys, the three metals form one ternary eutectic alloy, and three binary eutectic alloys; and the total number of metals and alloys can be seven, as shown in the ternary phase diagram in FIG. 2A. For any given number of metals that can generate binary eutectic alloys among any two of them, the numbers of binary, ternary and quaternary alloys and so on can be derived graphically from Pascal's triangle, as shown in FIG. 2B. The total number of metals and eutectic alloys that have sharp melting peak is (i.e. Eq. 2):

$${\sum }_{k = 1}^{n} {C}_{n}^{k} - 1 = {\sum }_{k = 1}^{n} \frac{n !}{k ! ( n - k ) !} - 1 = {2}^{n} - 1 \qquad Eq . 2$$

where n is the total number of metals, and k is the number of metals in one nanoparticle. Note that the combination corresponding to no metal (where n is 0) should be removed.

Coding Space of Thermal Taggants:

The taggants of the present disclosure provide a large coding space, that is, there are many unique thermal readouts or signatures that can be created with the taggants of the present disclosure. 100 types of nanoparticles with distinct melting temperatures can be used to construct covert taggants with the total combination of (2¹⁰⁰-1) or 10³⁰, which is large enough to cover each document, currency note, bullet or vehicles

Taggant Detection Limit:

Taking the root mean square (RMS) noise of a commercial DSC instrument as 0.2 μW, the minimal detectable heat flow can be 0.2 μJ for a 1° C. wide peak at ramp rate of I° C./second. This heat can cause melting of 3.8 ng bismuth (latent heat of 52 J/g). If 30 nm diameter bismuth nanoparticles (density of 9.7 g/cm³) are used, 3.8 ng bismuth can be enclosed in 30 microspheres (diameter of 5 μm). Increasing ramp rate to 60° C./second can reduce the number of microsphere to 5. Using more sensitive DSC can also reduce detection limit.

Stealthiness:

Nanoparticles cannot be seen without advanced microscope. Even when including a casing, the thermal taggant of the present disclosure can be too small to be observed with naked eye. In addition, nanoparticles or microparticles at such small size can be easily mixed with powders and explosive, added into bioweapon and inks, dispersed in liquid, or attached on solids without being noticed as smart dusts. The covert taggants can have exactly the same appearance as silica particles that are omnipresent in nature, thus cannot be discriminated even with high resolution microscope. The smart dust can be recovered without losing integrality and detected with DSC.

Stability:

The nanoparticles and silica or polymer shells are stable at ambient condition. It is possible that metal may be oxidized and the resulting oxide can have high melting temperature than metals, thus changing code of taggant. For many metals, if there is an oxide layer formed on metal, further oxidization can be avoided, and metallic core can still undergo solid-liquid phase change at designed temperature. Taggants made of organic solids or inorganic materials such as salts and ceramics can be stable against oxidation. At room temperature, covert taggants can be able to withstand extreme weather conditions with expected lifetime as long as several years.

Anti-Reverse Engineering:

The thermal taggants of the present disclosure may be designed so that it can be extremely difficult or impossible to reverse-engineer them. People outside government agency or designated company that manufacture taggants can have a hard time trying to figure out how to imitate taggant system, because nanoparticles cannot be seen or touched. Characterizing nanoparticle compositions can require sophisticated instruments (i.e., transmission electron microscope) that are only available at limited research organizations. Generating a large panel of nanoparticles of different compositions can be a huge challenge to non-professionals due to multiple materials and defined atom ratio.

In addition, in some embodiments, multi-functional taggants can be built by incorporating thermal, magnetic and fluorescent nanoparticles together, which provides multi-layered authentications that are even more difficult to be reconstructed. In some embodiments, multi-layer authentication that combines overt and covert layers can be employed. Such combined system may provide significant barrier to counterfeit or simulation, where overt layer is for public use, semi-covert layer for field use, and covert layer for investigative or forensic use. In some embodiments, multi-functional microspheres can be provided. For example, both covert thermal taggants and overt fluorescent taggant can be encapsulated inside silica or polymer microspheres with super-paramagnetic iron oxide nanoparticles (for taggant collection). The magnetic collection allows elimination of separation and extraction step. In some embodiments, iron oxide nanoparticles and cadmium sulfide/zinc sulfide quantum dots can be used. Quantum dots of different color can be used to form overt layer. These taggants can be extracted and recovered from powers (dust), papers or liquid extracts. The ratios of thermal, magnetic and fluorescent nanoparticles, can be tuned to achieve a balanced combination of multiple functions. In various embodiments, the structure, magnetic and fluorescent properties of multi-functional taggant can be tested by using, in addition to a DSC, scanning electron microscope (SEM), Superconducting Quantum Interference Device (SQUID), and fluorometer. The multi-functional taggants can be embedded in resin, cut to thin slices, and imaged with TEM to confirm existence of multiple nanoparticles.

In some embodiments, the present disclosure provides methods for using the taggants of the present disclosure for identification and analysis of evidence. In some embodiments, there is provided a method for identifying an object comprising thermally scanning a sample of an object comprising a plurality of phase change nanoparticles of one or more types having different phase change temperatures; generating a thermal readout of the object based on the one or more types of the nanoparticles embedded in the object; and identifying the object by matching the thermal readout of the article with a thermal readout in a library of thermal readouts. The library of thermal readouts can be developed by obtaining a thermal readout of a taggant incorporated into an object and associating this thermal readout with the object in a database. In some embodiments, there is provided a method of tagging an object comprising adding to an object a plurality of phase change nanoparticles of one or more types having different phase change temperatures. A thermal readout of the phase change nanoparticles can then be generated and associated with the object in the library of thermal readouts.

The methods of the present disclosure may be used in various forensic science disciplines, such as forensic scene analysis, controlled substances, tire debris analysis and arson investigations, firearms and toolmark identification, latent print, questioned documents, and trace evidence, and provide high impact and revolutionary improvement to intelligence-gathering and surveillance capabilities as microdots. A primary advantage of thermal taggants is high level of multiplicity, which can allow law enforcement, intelligence and security agencies to track, trace, identify and authenticate an extremely large number of objects/targets including documents, explosives, criminals and terrorists. The thermal taggants can offer criminal investigation abilities to allow low cost, robust, more informative and less labor-intensive identification and analysis of evidence through several ways.

The following are non-limiting examples of various forensic applications using the taggants of the present disclosure. However, it is noted that other types of applications are contemplated such as commercial investigations, non-commercial investigations, identification related activities, coding related applications, etc.

Tracking-Tracing Objects:

Intelligence agencies and law enforcement have a limited ways to find, identify and track unconventional targets such as individuals and insurgents or terrorists. Uniquely tagging individuals and mapping contact network among a group of individuals could provide a powerful new tool to fight organized crimes or terrorism. Thermal taggants can be used covertly to map interactions among groups of individuals that are suspected of plotting terrorist activities without risk and cost of continuous visual surveillance. Covert taggants with extremely high labeling capacity could be added into explosive or paint of vehicle so that each explosive or vehicle has its own unique taggant. The efficiency of law enforcement or security agency can be greatly enhanced by tracking taggant to manufacturer, vender or purchaser. Thermal taggants can be introduced into a potential bioweapon or related chemicals, and used to identify people that have contacted such items. Thermal taggants covertly embedded inside currency note can help to trace money laundering or track money path of organized crime or terrorist financing. Covert thermal taggants can also provide physical evidence in courts of law.

As noted above, phase change nanoparticles offer a large spectral capacity which provides many advantages over known techniques related to spectroscopic techniques, coding systems or identification related applications. For example, peak overlapping is an issue for many spectroscopic techniques, which limits their spectral capacities. The spectral capacity is dependent on peak width and spectral scan range. For a normal DSC machine, the peak width at half height of metallic nanoparticles (i.e., metal and eutectic alloy) can be smaller than 0.6° C. at thermal ramp rate of 1° C. per minute. As noted above, if thermal scan is in the 100-700° C. range, the maximal number of melting peaks that can be resolved will reach 1,000 based on Rayleigh's criterion on spectral resolution, which means 1,000 different types of nanoparticles (of distinct melting peaks) can be simultaneously detected in one thermal scan. One DSC run can produce any barcode from a system of 50 types of phase change nanoparticles or more. As an example, a system that consists of 50 types of phase change nanoparticles may be able to form a total of (2⁵⁰-1) or 10¹⁵ different barcodes. Table 1 below presents non-limiting examples of materials that can be used to form phase change nanoparticles of the present disclosure.

TABLE 1
Exemplary materials for nanoparticles

| | Composition | Melting point (° C.) | Latent heat (kJ/mol) |
|---|---|---|---|
| 1 | Bi_{0.32}In_{0.51}Sn_{0.17} | 62 | 6.34 |
| 2 | Bi_{0.22}In_{0.78} | 72.68 | 5.48 |
| 3 | Bi_{0.45}Pb_{0.34}Sn_{0.2} | 95.25 | 8.21 |
| 4 | Bi_{0.5}In_{0.5} | 109.36 | 7.56 |
| 5 | In_{0.53}Sn_{0.47} | 118.06 | 5.34 |
| 6 | Bi_{0.55}Pb_{0.45} | 124 | 7.99 |
| 7 | Bi_{0.58}Sn_{0.42} | 138 | 9.178 |
| 8 | In | 156 | 3.28 |
| 9 | Pb_{0.27}Sb_{0.05}Zn_{0.68} | 179.1 | 7.22 |
| 10 | Pb_{0.26}Sn_{0.74} | 183 | 6.45 |
| 11 | Au_{0.67}In_{0.15}Sn_{0.18} | 211.48 | 10.22 |
| 12 | Au_{0.62}In_{0.21}Sn_{0.17} | 221.67 | 9.79 |
| 13 | Ni_{0.43}Sn_{0.57} | 231.14 | 11.51 |
| 14 | Sn | 232 | 7.03 |
| 15 | Pb_{0.76}Sb_{0.18}Sn_{0.06} | 237.8 | 7.65 |
| 16 | Au_{0.65}Sb_{0.1}Sn_{0.25} | 243.38 | 11.87 |
| 17 | Pb_{0.82}Sb_{0.18} | 250.15 | 7.41 |
| 18 | Au_{0.63}Pb_{0.12}Sn_{0.25} | 265.75 | 10.19 |
| 19 | Bi | 271.15 | 11.30 |
| 20 | Au_{0.69}Sn_{0.31} | 283.84 | 10.85 |
| 21 | Ni_{0.2}Sb_{0.3}Sn_{0.5} | 291.76 | 12.83 |
| 22 | Au_{0.42}Sb_{0.25}Sn_{0.33} | 313.67 | 12.59 |
| 23 | Pb | 327.65 | 4.77 |
| 24 | Ag_{0.52}Sb_{0.25}Zn_{0.23} | 335.93 | 12.43 |
| 25 | Au_{0.33}Sb_{0.67} | 353.29 | 17.38 |
| 26 | Au_{0.32}Cu_{0.34}Sb_{0.34} | 363.54 | 15.21 |
| 27 | Au_{0.61}In_{0.29}Zn_{0.1} | 369.82 | 9.94 |
| 28 | Al_{0.11}Au_{0.59}Sn_{0.3} | 379.69 | 10.65 |
| 29 | Au_{0.52}Sb_{0.3}Zb_{0.18} | 393.84 | 13.77 |
| 30 | Cu_{0.37}Sb_{0.37}Zn_{0.26} | 398.75 | 14.12 |
| 31 | Au_{0.57}Cu_{0.08}In_{0.35} | 406.35 | 9.56 |
| 32 | Ag_{0.08}Al_{0.1}Au_{0.49}In_{0.33} | 412.75 | 9.39 |
| 33 | Zn | 419.75 | 7.32 |
| 34 | Al_{0.13}Au_{0.5}Sb_{0.37} | 428.28 | 15.00 |
| 35 | Al_{0.14}Au_{0.56}In_{0.3} | 434.11 | 9.61 |
| 36 | Bi_{0.33}In_{0.37}Zn_{0.30} | 439.99 | 7.31 |
| 37 | Au_{0.24}Cu_{0.43}In_{0.33} | 447.65 | 9.96 |
| 38 | Au_{0.64}In_{0.36} | 452.6 | 9.38 |
| 39 | Ag_{0.12}Al_{0.28}Au_{0.39}Cu_{0.21} | 457.2 | 12.02 |
| 40 | In_{0.2}Sb_{0.64}Zn_{0.16} | 466.86 | 14.67 |
| 41 | Al_{0.18}Au_{0.65}Zn_{0.17} | 472.28 | 11.32 |
| 42 | Ag_{0.57}Sb_{0.43} | 478.45 | 14.90 |
| 43 | Al_{0.33}Au_{0.46}Cu_{0.21} | 493.61 | 12.09 |
| 44 | Cu_{0.35}In_{0.56}Zn_{0.09} | 503.22 | 7.48 |
| 45 | Al_{0.24}Au_{0.61}Cu_{0.15} | 513.81 | 12.21 |
| 46 | Cu_{0.67}Sb_{0.33} | 526.24 | 15.41 |
| 47 | Al_{0.68}Au_{0.32} | 548.14 | 11.29 |
| 48 | Ag_{0.05}Al_{0.26}Au_{0.69} | 554.04 | 12.00 |
| 49 | Ag_{0.33}Al_{0.67} | 566.03 | 10.90 |
| 50 | Bi_{0.11}Cu_{0.66}In_{0.23} | 603.02 | 10.87 |

In some embodiments, the barcode can be compared and matched to known DSC scans. In some embodiments, the barcode can be easily digitalized, where the presence of one peak will be denoted as 1, and the absence of one peak will be denoted as 0. One of the thermal barcodes in the 50 system can be 00000000001111111111000000000011111111110000000000. The lowest temperature and the highest temperature are 62 and 603° C., respectively. This barcode can be readout in 5 min when DSC machine is operated at thermal ramp rate of 100° C./min.

Anticounterfeiting:

Counterfeiting costs legitimate businesses upward of $500 billion per year. Thermal taggant can be used for authentication applications by mixing with inks, varnishes, plastics and paper. Covert taggants embedded in government documents can generate additional revenue, make counterfeiting much less profitable, and reduce number of counterfeits on market. Thermal taggants can be used in government-issued documents as unique and forensically covert identifiers. Due to their small size, thermal taggant can be combined with other security features to form multi-layer authentication system, where overt layer is for instant verification and covert layer is for forensic investigation. In many cases, such multi-functional multi-layer taggants can elude knowledge of counterfeiter, and can be extremely difficult to be reconstructed. In addition, thermal taggants can be highly durable, and can withstand extreme weather conditions.

Tamper Detection:

Thermal taggants can be used by Department of Homeland Security to determine whether a container or object has been opened or tampered. The tamper detection can take advantage of the fact that thermal taggants are invisible to naked eyes and can be transferred by contact. Border patrol agents can perform quick wipe-test of shoes to determine if pedestrians in sensitive areas have passed through areas, which are forbidden and flagged with taggant. Law enforcement can label suspects through aerosol spraying for positive identification of individual suspect. The military can use thermal taggants at checkpoints to verify that vehicles or personnel are traveling within allowed corridors and to corroborate driver's story of vehicle travel history. It is also possible to combine magnetic nanoparticles in micro-spheres to have taggants that can be magnetic collected from dust, powder or liquid elute. The magnetic enrichment can greatly enhance sensitivity for thermal taggants.

Compared to optical taggants, the thermal taggants have extremely high multiplicity or coding space, and are very difficult to be noticed or imitated. Compared to DNA taggants, the thermal taggants have similar sensitivity, are much more robust, easy to read, and much cheaper. Compared to taggants based on intaglio features, lithographic microscale features and radio frequency devices, thermal taggants that can be readily mixed with or attached on objects are much cheaper and more versatile to achieve a variety of covert tagging mission. The unique combination of large multiplicity, high sensitivity, ease-of-use, covertness, low-cost, track-and-trace ability, stability and transferability in thermal taggants allows forensic investigations to be carried out at high efficiency, less risk and low cost. For example, costs related to each cover thermal barcode may be approximately $0.5 or less. A handheld thermal barcode ready may cost approximately $1,000 or less. Other than the examples outlined, there are many other forensic areas that can be benefited from this ground-breaking and revolutionary technology.

For example, the phase change nanoparticles offer a high sensitivity, wherein the sensitivity of barcode readout is determined by the lowest detection limit of DSC, which corresponds to the smallest melting peak that can be distinguished from background noise. Taking the root mean square (RMS) noise of a DSC machine (PerkinElmer 7) as 0.2 μW, the peak signal that can be recognized from background noise will be 0.2 μJ for a 1° C. wide peak at thermal ramp rate of 1° C./second (60° C./min). If copper (latent heat of 205 J/g) is used to make phase change nanoparticles, the lowest detectable mass of copper nanoparticles is calculated to be 1 ng. Given that any practically detectable signal should be 1000 times higher than the noise, the detection limit for copper nanoparticles will be 1000 ng (1 μg). In reality, 0.1-0.001% percent (by mass) of indium and bismuth nanoparticles has been detected in explosive and polymer ink, as well as in paper with DSC.

The present disclosure further provides methods for producing the taggants 100. In some embodiments, colloid synthesis method can be used to create the taggants of the present disclosure.

In some embodiments, the nanoparticles of the present disclosure can be designed based on materials property analysis. These nanoparticles can be made using a variety of methods such as, by way of a non-limiting example, colloid method, vapor deposition, lithography, polymer self-assembly, or simple mechanical milling, among many others. From a large number of nanoparticles, various unique taggants can be created. A panel of nanoparticles can be directly incorporated onto or into object, or can be encapsulated into a micro casing, which can then be added into or attached onto an object.

In some embodiments, metal compositions of nanoparticles may be obtained and nanoparticles can be made by thermally decomposing precursors at stoichiometric ratios in presence of polyvinyl alcohol (PVA) used as surfactant in a high boiling point solvent (i.e., ethylene glycol). In order to avoid size-dependent melting point change, the diameter of nanoparticles can be controlled within 20-200 nm range by changing molar ratio of surfactant and precursor. To prevent diameter variation of nanoparticles, surfactant micelles that contain homogeneous solutions of precursors can be generated prior to thermal decomposition, and the thermal decomposition can be carried out at lower temperature. A combinatorial approach can be used to make nanoparticles, where organometallic precursors at desired ratio can be added in a ceramic plate with multiple wells (96). The plate can be placed inside a chamber filled with nitrogen gas, and heated to 200° C. to decompose precursors. After forming nanoparticles, the compositions of eutectic alloy nanoparticles can be derived by atomic emission spectrometry after dissolving nanoparticles in aqueous solution of hydrogen chloride. X-ray diffraction analysis (XRD) and TEM can be used to determine crystalline structures and morphologies of nanoparticles; energy dispersive X-ray analysis (EDX) can be used to confirm compositions of nanoparticles; the composition dependent latent heat and melting temperature of eutectic alloy nanoparticles can be determined by using DSC. The latent heat of fusion of each type of nanoparticles can be normalized. From a total of 63 types of nanoparticles, 20 types can be selected and their ratios of latent heats can be used to determine their according masses in silica casing so that the fusion enthalpy of each type of nanoparticles (if present) inside a thermal taggant can be comparable to other type of nanoparticles.

Among many methods to form taggants from a panel of nanoparticles, a high throughput digital printing technique can be used to assemble different types of nanoparticles to form taggants. After forming a homogeneous mixture, nanoparticles can be embedded into silica microspheres with two methods identified as homogeneous nucleation and heterogeneous nucleation. In the homogeneous approach, TEOS precursor can decompose inside a solution that contains a mixture of nanoparticles, and nanoparticles are randomly distributed in silica microsphere. In the heterogeneous approach, silica nanoparticles can be first made through a homogeneous nucleation process, and modified with 3-aminopropyltriethoxysilane (APTES) to be positively charged. The nanoparticles can be modified to have negative charges by forming a thin film of polyacrylic acid (PAA). The nanoparticles can be added into the silica nanoparticle solution, and adsorbed on silica nanoparticles through electrostatic attraction. Then another layer of silica nanoparticles can be electrostatically attached. By repeating this process for few times, multiple nanoparticles can be coated around silica nanoparticles. Both methods can be compared in terms of encapsulation efficiency, and size distribution of microsphere. The nanoparticles can be encapsulated in polystyrene microspheres to meet different needs such as mixing with printer ink or toner. In order to confirm encapsulation of metallic nanoparticles inside polymer or silica microspheres, the microspheres can be embedded inside resin, and cut to form thin slices. After collection the thin slice onto copper grid, the nanoparticles can be imaged using TEM. Instead or making a full set of taggants, several taggant compositions can be randomly selected, produced and characterized in this proof-of-concept project.

In some embodiments, the surface of nanoparticles or microspheres can be modified so that the taggants of the present disclosure cannot be distinguished from their hosts, and cannot be removed easily. Depending on final use, the nanoparticles or casing surface can be modified to be either hydrophobic or hydrophilic by using standard surface chemistry method. To form hydrophobic coating, silica microspheres can be dispersed into 5% solution or octadecyltrichlorosilane (OTS) in acetone. To form hydrophilic coating, silica casing can be dispersed in 5% solution of APTES in ethanol. The nanoparticles or modified silica casings can be embedded into commercial hydrophobic or hydrophilic inks or paints, and applied on various surfaces (metal, wood, plastic, skin, clothes, soil and money).

In order to determine how well thermal taggants mix with the host, a mixture of laser printer ink from Hewlett-Packard and taggants can be made at certain mass ratio, refilled back to cartridge and printed on paper. A small amount of printed ink can be scratched and dissolved in acetone to remove organic components, followed by DSC readout. A variety of substrates can be tested to determine whether nanoparticles or silica microspheres can be applied with printing technologies on any substrates. In order to determine whether nanoparticles or silica microspheres attached on a solid surface can be transferred to another surface (to map network of interaction), an aerosol containing thermal taggants can be applied on hand, followed by several series of physical touch (i.e., handshakes). After each touch, the taggants can be collected from the second surface, and tested to determine yield of transfer. The amount of nanoparticles or microspheres after each contact can be determined by washing surfaces thoroughly, collecting nanoparticles or silica microspheres using centrifugation, and thermally detecting signature of thermal taggants. The thermal taggant can be mixed with dust and collected after certain time to determine how much taggants can be recovered. Magnetic nanoparticles can be encapsulated together with a panel of phase change nanoparticles. An external magnet can be used to collect covert taggants. The thermal taggant can also be added in explosive. After detonation, debris can be collected and processed to extract taggant. The collected taggants can be analyzed using DSC to determine how much taggants remain. In order to have strong affinity to target surface, the microspheres can be modified with reactive functional groups (such as epoxy), which can form strong covalent bonds with many surfaces.

Thermal readout conditions may depend on a variety of factors, such instrument detection limit and thermal scan conditions. The thermal scan conditions for taggant readout can be studied as follows. (1) The lowest detection limit of DSC instrument can be determined by measuring heat flows of thin film materials deposited on aluminum substrates. (2) The effects of size, mass, composition, and shell thickness of nanoparticles on analysis time (ramp rate), peak width (multiplicity) and peak area (sensitivity) can be studied by DSC. (3) Helium gives 30-45% decrease in peak width for solid-liquid phase change due to enhanced thermal conductivity. The atmosphere effect on peak width can be studied by doing DSC in air, nitrogen, and helium. (4) In the case that 100 different types of nanoparticles are used, the thermal readout condition can be optimized to discriminate melting peaks with an average temperature difference of 5° C. (5) The thermal taggants recovered from dust, ink and surface may contain contamination, and can be treated with different solvent prior to thermal readout. The effect of residue contamination and solvent on thermal readout can be tested. (6) The maximal amount of nanoparticles can be encapsulated inside microsphere, and used to explore the minimal number of microspheres that can be detected with existing DSC. The detection of single casing can be explored by optimizing sizes of the casings, amount of encapsulated nanoparticles, as well as thermal readout conditions.

The present disclosure also provides chip-scale DSCs for field deployable readout and fabrication methods for such DSCs. For example, a handheld power compensation DSC can be built for field deployable application using CMOS-compatible silicon microfabrication techniques. Due to its reduced thermal mass, chip-scale DSC can allow high thermal scan rate. A resistive heater and a temperature sensor can be incorporated in calorimetric cell for heating and temperature sensing, respectively. Each cell can consist of a suspended plate, four supporting beams, and four electrodes to measure conductance of thin film. The sample temperature can be scanned at a constant rate. The output voltage can be monitored by nanovoltmeter. The on-chip heater can be connected to a universal power supply to apply a known amount of Joule heating power to chamber during calibration. A computer with a Labview program can be used to automate measurements. The thermal taggants collected from different sources (dusts, and surfaces) can be deposited on heater and tested for their thermal signatures. The peak width and area, and the highest ramp rate can be determined.

The methods and materials of the present disclosure are described in the following Examples, which are set forth to aid in the understanding of the disclosure, and should not be construed to limit in any way the scope of the disclosure as defined in the claims which follow thereafter. The following examples are put forth so as to provide those of ordinary skill in the art with a complete disclosure and description of how to make and use the embodiments of the present disclosure, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

### EXAMPLES

### Example 1

### Synthesis and Characterization of Nanoparticle

nanoparticles can be made by using different methods such as colloid method, lithography method, vapor deposition method, etc. Here an example of making nanoparticles using colloid method is given. Bismuth nanoparticles are made by thermally decomposing organometallic precursor: 1 mmol bismuth acetate is added in 20 ml ethylene glycol with 0.2 g polyvinylpyrrolidone (PVP) as surfactant. After heating at 200° C. with magnetic stirring for 20 min, the solution is quenched in 0° C. ethanol (200 ml). The same method has been used to make indium, and lead nanoparticles. In order to make lead-tin eutectic nanoparticles, 0.37 mmol lead acetate and 0.67 mmol tin acetate are added in 20 ml ethylene glycol with 0.2 g PVP. The mixture is heated to 200° C. while stirring to decompose precursors in nitrogen atmosphere. After reaction (20 min) the mixture is quenched in 0° C. ethanol. Nanoparticles are separated by centrifuging at 4000 rpm for 10 min and washed with ethanol. Bismuth nanoparticles are checked by scanning electron microscope (SEM) and transmission electron microscope (TEM). The size of nanoparticles has been controlled by changing ratio of precursor and surfactant.

FIG. 3A and FIG. 3B show SEM and TEM images of bismuth nanoparticles that have an average diameter of 200 and 30 nm, respectively. The thermophysical property of bismuth nanoparticles has been tested with DSC (FIG. 3C), where nanoparticles melt at the same temperature as bulk bismuth (271° C.), and the peak area is proportional to nanoparticle mass. FIG. 3D shows the relation between ramp rate and peak width, where the peak width can be less than 1° C. at low thermal ramp rate. In addition, super paramagnetic iron oxide nanoparticles and semiconductor quantum dots have been made as well. FIG. 3E and FIG. 3F show TEM image of iron oxide nanoparticles, and fluorescence emission from 3 different sized lnP/ZnS core shell nanoparticles, where the colors of quantum dots are determined by sizes. Magnetic and fluorescent quantum dots can be used together or encapsulated together with phase change nanoparticles inside microspheres to form multi-functional taggant for multi-layered authentication with enhanced secureness.

### Example 2

### Encapsulation of Phase Change Nanoparticles

Bismuth nanoparticles have been coated in inside silica shells by using sol-el method. Silica is made around nanoparticle using tetraethoxysilane (TEOS) as precursor. After re suspending 50 mg nanoparticles into 50 ml of ethanol, 2 ml of NH₄OH at concentration of 28%, and 0.2 ml of TEOS are added drop-wisely into solution. The mixture is sonicated at 70° C. for 1.5 hours to decompose TEOS and produce silica shells around nanoparticles. After reaction is complete, the mixture is centrifuged and nanoparticles are washed by ethanol for three times. The thickness of silica shell can be controlled from 10 to 80 nm by changing the ratio of nanoparticles and TEOS. Silica has high melting point, excellent thermal/chemical stability, and thermal shock resistance.

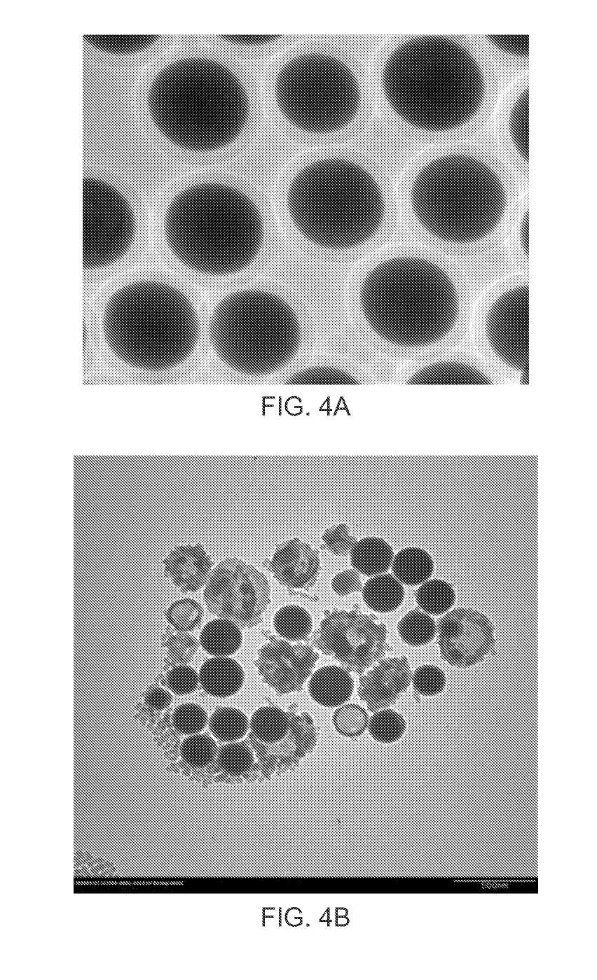

FIG. 4A shows the TEM image of bismuth nanoparticles encapsulated in silica shell, where core-shell structure can be seen clearly due to low electron contrast of silica shell compared to bismuth core. The silica shell protects bismuth core from agglomeration during melting. In order to test stability of shell, silica encapsulated bismuth nanoparticles are heated up to 700° C. inside a TEM. The in-situ heating TEM shows that no agglomeration, leakage or oxidation of bismuth is found at temperatures up to 300° C. Silica shells are well preserved when temperature is lower than 500° C. FIG. 4B shows a TEM image of silica encapsulated bismuth nanoparticles at 600° C., where the moderate leakage and loss of bismuth are observed. The rupture of silica shell at high temperature is likely due to high vapor pressure of bismuth above its melting temperature (271° C.).

### Example 3

### Encapsulation of Multiple Types of Nanoparticles

A panel of four nanoparticles with compositions of Field's alloy, indium, tin, and lead-tin eutectic alloy are embedded in silica microsphere as follows. A silica sol is formed by adding 0.7 ml of TEOS and 0.3 ml of 0.05M HCI in water with ultrasonic stirring for 10 min. An aqueous solution of phase change nanoparticles are added at the final concentration in the range of 5-20% (v). The solution is then mixed with the silica sol, followed by adding 8 ml toluene containing 320 μl Tween-20 and 80 Li Span 80. The volume ratio of organic phase to silica sol is 8:1. 1.2 ml of 1% ammonia hydroxide solution is added quickly, leading to formation of silica microsphere.

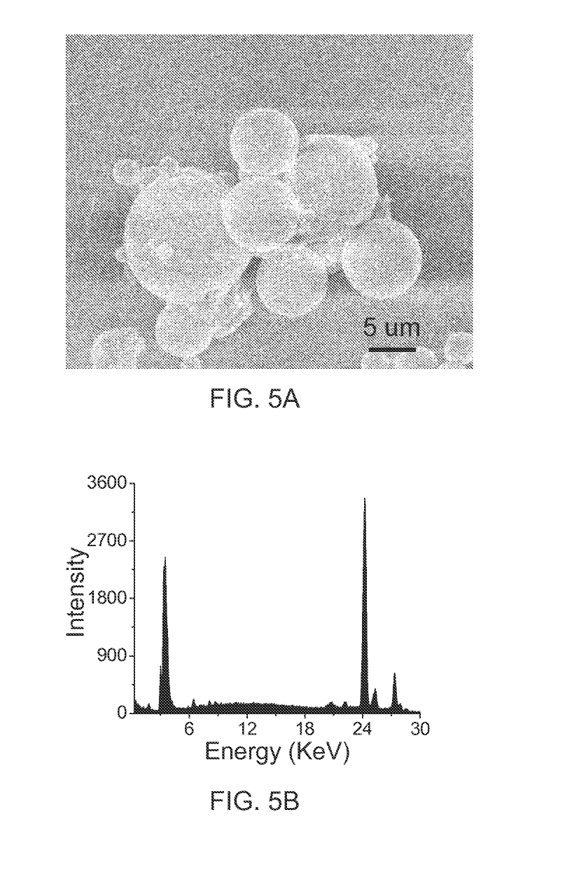

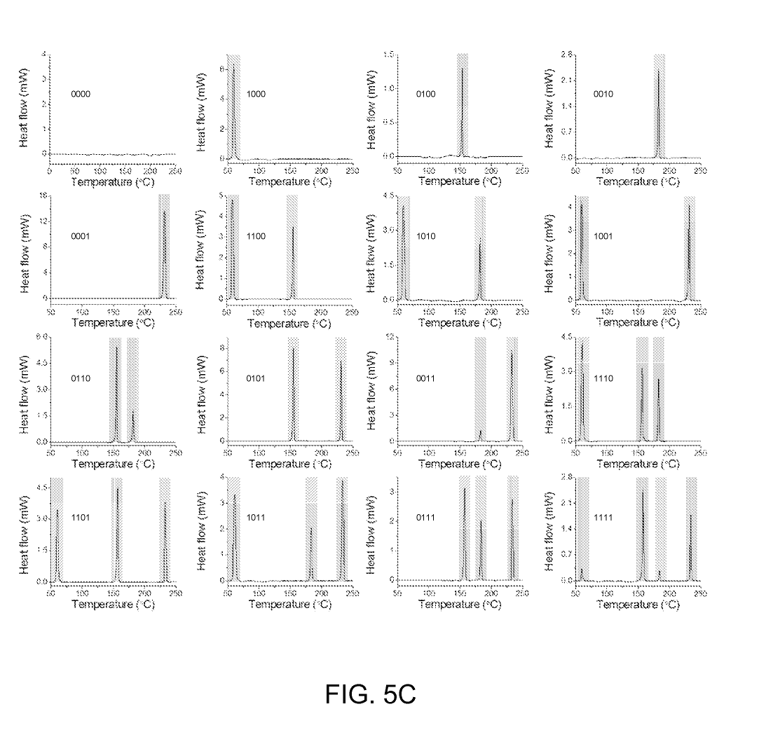

FIG. 5A is an SEM image of silica microsphere containing indium and tin nanoparticles, where the average size of silica particles is 10 μm. The composition of silica microspheres is derived by XRF as in FIG. 5B, where Lα₁, Kα₁ and Kα₂ lines of indium at 3.29, 24.21, and 27.27 keV, and Kat line of tin at 25.27 keV can be found, confirming encapsulation of indium and tin nanoparticles. The TEM image of microspheres does not show contrast because electron beam cannot pass through microspheres. The melting points of nanoparticles of Field's alloy, indium, lead-tin eutectic alloy and tin are 62, 156, 183 and 232° C., respectively. The number of thermal taggants that are formed by four type of nanoparticles is 15. FIG. 5C shows DSC curves of 16 different types of silica microspheres, where each melting peak can be denoted as one or zero depending on whether there is detectable heat flux or not. The 16 combinations of four elements are 0000, 1000, 0100, 0010, 0001, 1100, 1010, 1001 0110, 0101, 001, 1110, 1101, 1011, 0111, and 1111. The height (and area) of each melting peak is proportional to the mass of nanoparticles inside microspheres. In order to readout taggants, one thermal scan has been performed between 0-300° C. at ramp rate of 10° C./min (takes 30 min). The readout time can be greatly reduced by increasing ramp rates. The thermal readouts have been tested at scan rate as high as 50° C./min, where each taggant can still be distinguished and the readout time is 6 min. In addition, the thermal readouts have been performed for multiple times without reduction in peak intensity, suggesting that the oxidation of nanoparticle or leaking of molten cores is not an issue at low temperature.

### Example 4

### Synthesis of Organic Phase Change Particles and Process of Encoding and Decoding the Particles in a Target Drug

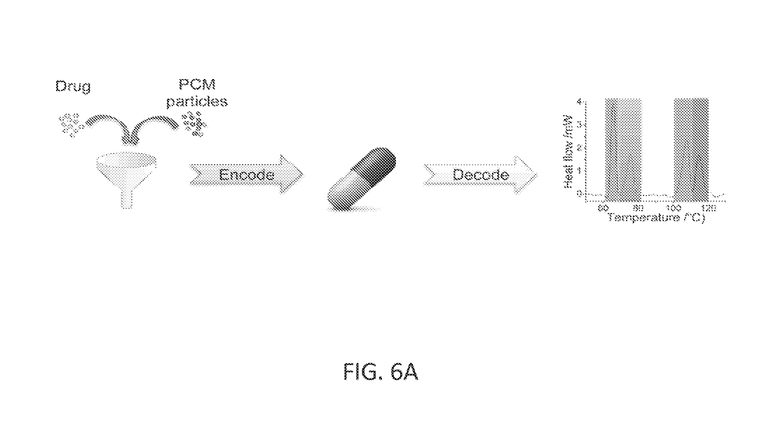

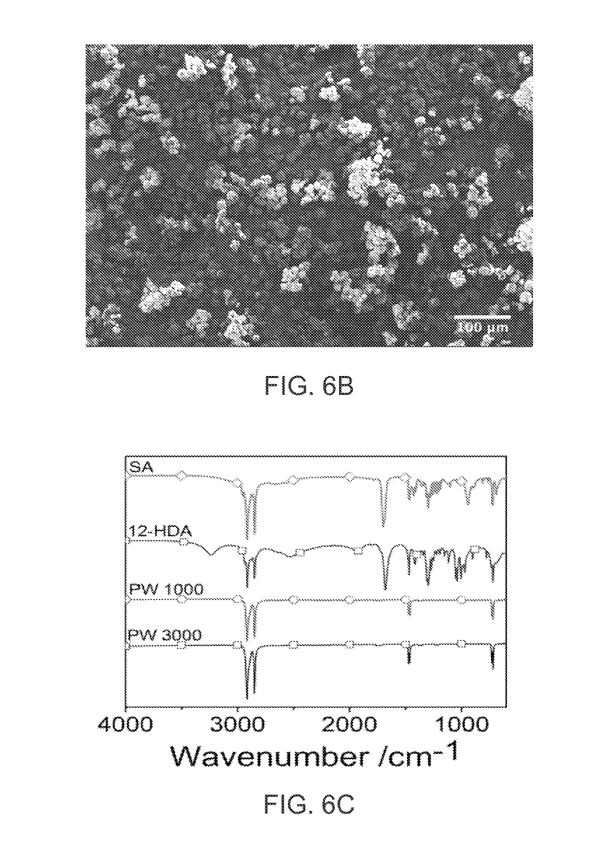

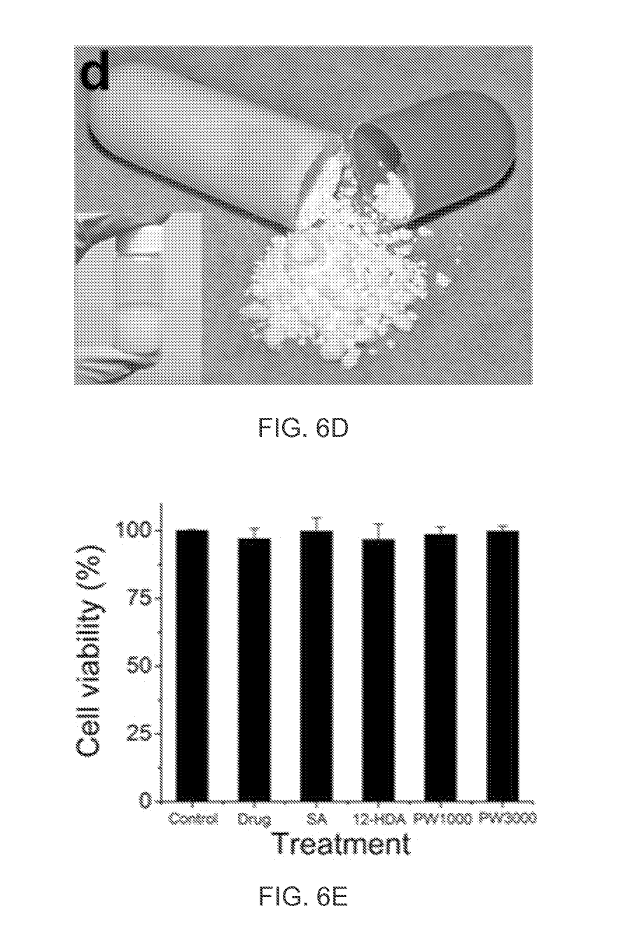

FIG. 6A illustrates how the phase change particles can easily encode a drug at the point of formulation. Decoding process can easily be achieved by performing a quick thermal scan. FIG. 6B is a SEM image of synthesized 12-HDA particles. FIG. 6C is a FTIR spectra that confirms the chemical structures of bulk PCM materials are still preserved in the synthesized particles. FIG. 6D is a photograph of acetaminophen after encoded with phase change particles. It is invisible to naked eye that the drug has been mixed with PCM particles. Suspension of stearic acid particles in water is shown in set. FIG. 6E is cytotoxicity study of the drug and phase change particles.

Four different organic PCMs were synthesized using simple water-in-oil emulsion reactions: stearic acid (SA, Tₘ=69° C.), 12-hydroxydodecanoic acid (12-HDA, Tₘ=80° C.), polywax 1000 (PW1000, Tₘ=110° C.) and polywax 3000 (PW3000, Tₘ=130° C.). Scanning electron microscopy and Fourier transform infrared (FTIR) spectroscopy were used to analyze morphology and chemical structures of the synthesized particles. As shown in FIG. 6B, uniform spherical 12-HDA particles of diameter in the range of 20-30 μm were obtained. Fourier transform infrared (FTIR) spectra confirm that the chemical structures of bulk PCM materials are still preserved in the synthesized particles (FIG. 6C).

To encode a drug, taking acetaminophen as a representative, the PCM particles were mixed homogenously with the drug as shown in FIG. 6D. The physical appearance of the drug after encoded with our thermal taggants is indistinguishable from the one before mixing under naked eye; hence, the encoded drug is completely protected from counterfeiters. Suspension of these particles is quite stable in water, suggesting a possibility of using it for authenticating liquid drugs as well (Inset in FIG. 6D). An important factor in incorporating any taggants in a drug is to verify that added markers do not alter functions of active ingredients in the drug. Cytotoxicity study as shown in FIG. 6E confirms that our particles does not have side effects on the viability of cells, indicating the biocompatibility of the organic PCM particles.

Additionally, these four chemicals that were used have been in the approval list of FDA to be used for pharmaceutical products, hence, inclusion of these particles in drugs is highly possible. Further, an ability to widen the number of available codes can improve the capacity of any security system. For the instant thermal taggant system, a new code can be created by forming a eutectic mixture of two compounds based on phase diagram knowledge. The composition of this compound can be predicted based on available information of melting temperature and Gibbs free energies of the two starting materials using equation (i.e. Eq. 3):

$${T}_{m} = {[ \frac{1}{{T}_{i}} - ( \frac{R - ln {X}_{i}}{{H}_{i}} ) ]}^{- 1} , i = A , B \qquad Eq . 3$$

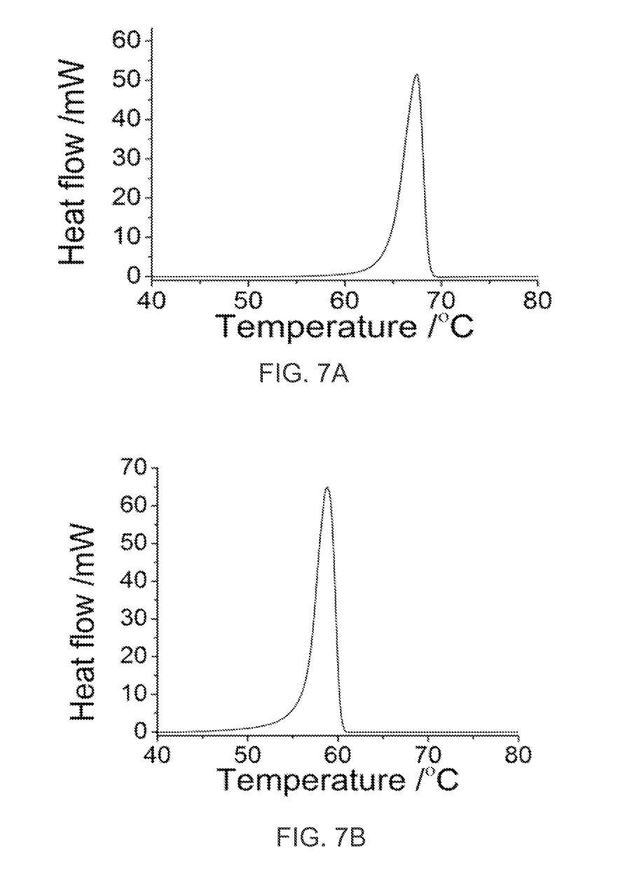

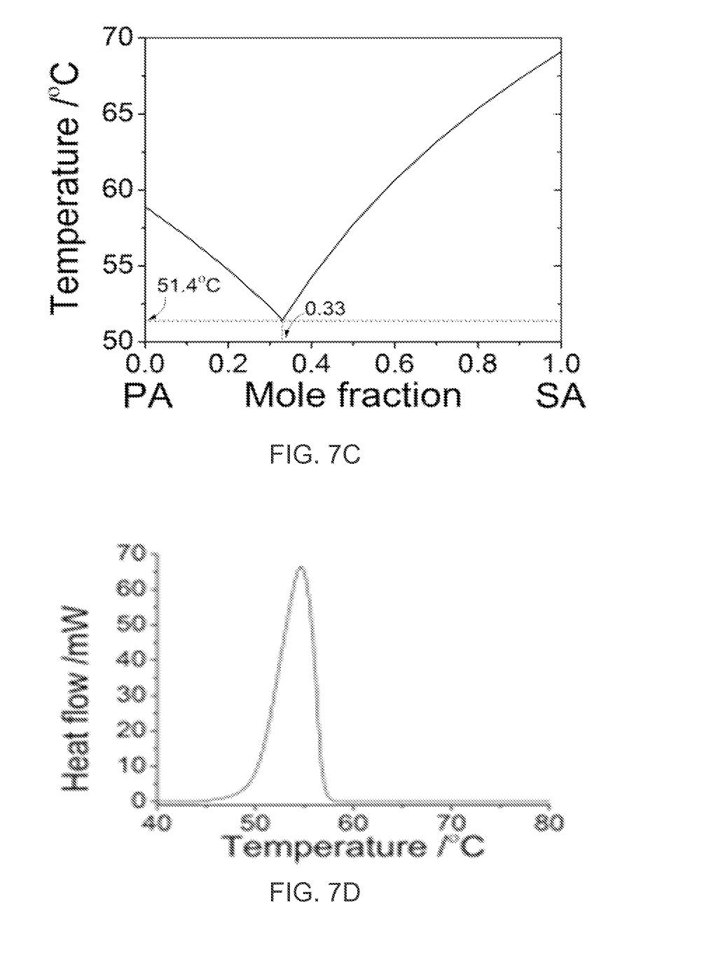

To demonstrate the feasibility of synthesizing eutectic particles, eutectic compound of stearic acid (SA) and palmitic acid (PA) was prepared. FIGS. 7A and 7B show the phase diagrams of palmitic acid and stearic acid with their corresponding melting temperatures peaks at 68° C. and 59° C. The phase diagram of SA and PA eutectic compound has been calculated and plotted in FIG. 7C. The eutectic PCM particles is expected to melt at about 52° C., which is in good agreement with our experimental value of 54° C. (FIG. 7D).

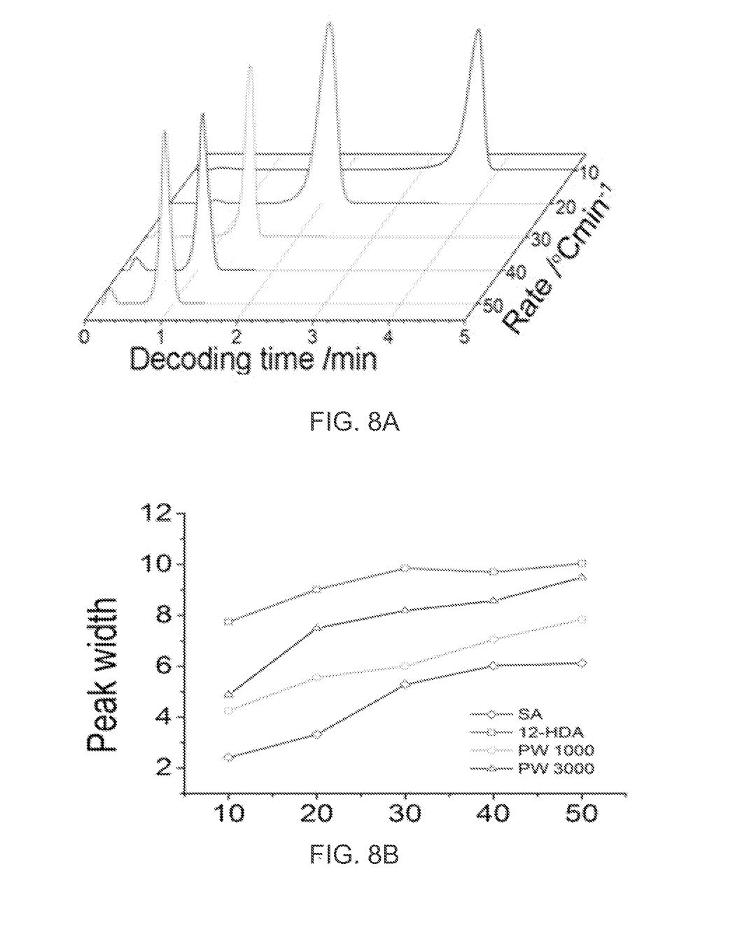

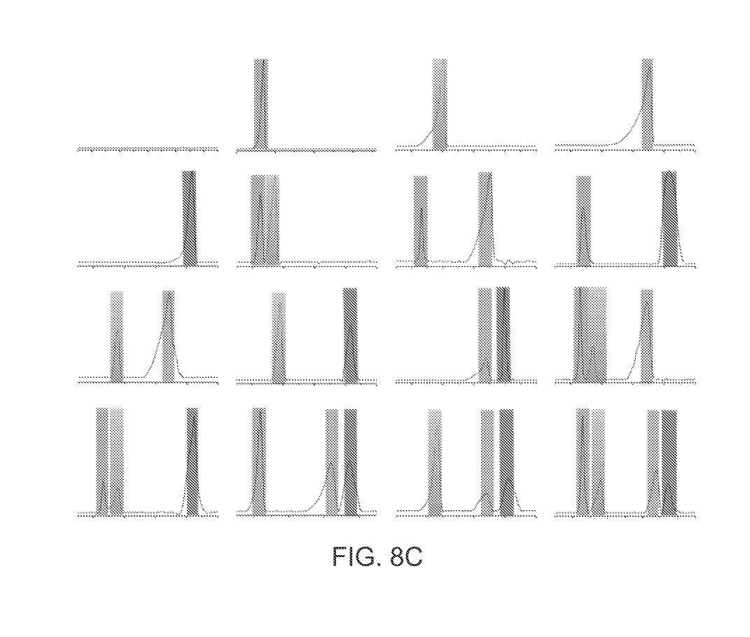

Decoding process can be easily accomplished by matching number of peaks and their positions through a quick DSC scan. A typical thermal scan from 30 to 100° C. will take about 5 minutes with a ramp rate of 10° C./min, however, this decoding time can be easier shorten by increasing the ramp rate. As shown in FIG. 8A, the decoding time can be shorten to less than 2 minutes if a ramp rate of 50° C./min was used. Resolution of SA peak at various ramp rates is shown in FIG. 8B. The peak width increases almost linearly with the ramp rate. However, the width can be remedied by decreasing the mass of the sample with each increase in heating rate. The sensitivity of decoding is dependent on the minimal heat flux that can be measured by DSC, and the lowest concentration of PCMs in the mixture. In order to produce detectable heat flow, it was found that a concentration of as small as 1 wt. % taggant particles should be used. The melting temperature of the particles is still identical even after heating them up to 150° C. for at least three thermal cycles, proving good thermal stability. Tablet is the most common pharmaceutical dosage form, however, tablet formation requires physical compression. To verify that our thermal taggant is also suited for labeling tablets, the mixture of drug and PCM particles was decoded after applying a pressure of about 1 MPa on the powder mixture. Pronounced melting peaks were still observed after compression, confirming that PCM particles can be integrated in tablet form as well.

One of the advantages of using thermal barcodes is that the sharp peak over a large temperature range, which offers a huge multiplicity of barcodes, providing sufficient numbers of compounds with designed melting temperature can be made. Assuming that the melting peak of each compound is sufficiently sharp and does not overlap each other, each melting is corresponding to specific particles. The number of codes can be derived graphically from Pascal's triangle or from the following equation (i.e. Eq. 4):

$${\sum }_{k = 1}^{n} {C}_{n}^{k} - 1 \approx {\sum }_{k = 1}^{n} \frac{n !}{k ! ( n - k ) !} - 1 = {2}^{n} - 1 \qquad Eq . 4$$

where n is the total number of melting peaks and k is the number of melting peaks in one combination. In a four-element system presented in this study, 15 different combinations can easily be formed (FIG. 8C). Each DSC curves was flatten to remove its slope and smoothened to remove thermal fluctuation. Since the number of available organic PCMs such as paraffin waxes, polyalcohol, polyethylene, fatty acids and their derivatives is obviously far beyond 20, ultrahigh capacity system of more than 100,000 thermal codes can be created, which offers an effective level of security for drugs.

Particles Synthesis:

2 g of a stearic acid was melted at 85° C. An aqueous solution contained 2 vol % of Tween 20 was heated to the same temperature. To obtain an oil-in-water emulsion, the molten fatty acid was slowly added into the heated aqueous solution while stirring. After 20 min, the emulsion was added into 0° C. water (300 ml). The particles were collected by centrifuging at 8000 rpm for 30 min, and washed thoroughly with water for three times. The same procedure was carried out to synthesize 12-HDA, palmitic acid (PA), and SA-PA eutectic particles.

0.03 g of PW 1000 or 3000 was added into 10 mL of heated toluene (100° C.). The solution was stirred constantly for about 20 minutes or until a white emulsion was obtained. Precipitation of polywax particles was collected by adding ethanol into the toluene solution. The particles were dried in an oven at 80° C. overnight.

Particle Characterization:

Morphology of the particles was studied using scanning electron microscope (Zeiss Ultra-55). Attenuated total reflection infrared spectroscopy (ATR-IR) was employed to analyze the chemical structures of the synthesized particles. Thermal characteristics of phase change particles were collected using a differential scanning calorimeter (PerkinElmer DSC 7). To prepare a DSC sample, an aluminum pan filled with ˜3-5 mg of a powder was hermetically sealed. Various heating rates were used to study the peak width of the PCM particles at their melting points.

Cytotoxicity Assay:

HeLa cells obtained from the American Type Culture Collection (ATCC, Manassas, Va.) were cultured in standard conditions (5% CO2 in air at 37° C.) in RPMI-1640 medium supplemented with 10% (v/v) fetal bovine serum and 1% (v/v) penicillin/streptomycin. A solution trypsinized with 0.25% trypsin/0.53 mM EDTA was used to trypsinized the cells. Viability of cells was determined by staining with Trypan Blue, and cell number was counted with a hemacytometer from Hausser Scientific (Horsham, Pa.).

The cytotoxicity was determined by viability (live/dead) assay as follows: 100 μL cell suspensions were seeded into each microwell of a 96-well microplate at final concentration of 1×10⁵ cells/mL. An additional 100 μL of LIVE/DEAD working solution was added, which yields 200 μL per well containing 1 μL Calcein AM and 2 μL Ethd-1. After being incubated for 30 min at room temperature, the fluorescence emission was collected using a microplate reader (Bio-Tek, Winooski, Vt.). The percentage of live and dead cells was calculated with the equation provide by Invitrogen. For cytotoxicity assay, six independent values were collected and the error bars in each figure represent the standard error of these six independent experiments. All data were presented as the mean with the standard deviation (mean±SD). The statistical significance of the results was determined by means of an analysis of variance using the SPSS software (SPSS 19.0). A result was considered statistically significantly different when p≦0.05.

### Example 5

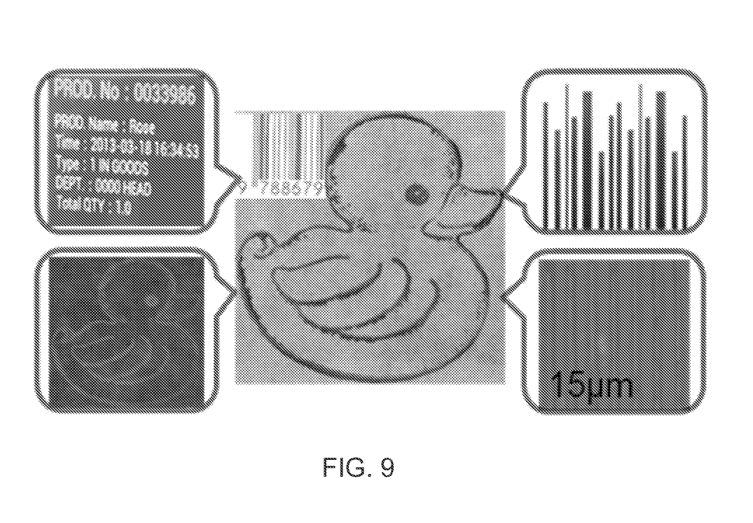

Synthesis and use of multilayer taggant system based on the use of phase change nanoparticles (metals and eutectic alloys), which can be added in matrix materials and printed on objects to form microscale features containing thermal and fluorescence signatures. FIG. 9 presents multilayer taggants with enhanced labeling security; this taggant contains three layers, namely, optical taggant, thermal taggant, and microtaggants. The high labeling capacity, small form effect, excellent coding readiness and covertness offered by phase change nanoparticles can greatly enhance security level for many applications.

### Example 6

The size of the phase change particles can range from 20 nm up to micrometers, or even millimeters. For example, FIG. 1 is the DSC curve of a piece of Bi—Pb—Sn alloy with size of ˜50 micrometer long and 30 micrometer wide, which was cut from a big block of alloy.

Materials and Characterization

Eutectic alloys of lead-bismuth (255), lead-bismuth-tin (281) (Rotometals), eutectic alloy of indium-tin (D.K.A. Metalloids), and eutectic alloy of tin-lead (Amerway) were used. Tin powder, bismuth powder, indium powder and high molecular weight polyvinyl alcohol (PVA) were from Alfa Aesar. Polyureasilazane (Kion) was used as polymer matrix. Rhodamine-6G (Acros) was used as fluorescence dye. Nail polish (Walgreen) that has major composition of poly (methyl methacrylate) (PMMA) was used.

The morphology of as-made nanoparticles was characterized by JEOL 1011 transmission electron microscopy (TEM), operated at 100 kV. TEM samples were prepared by dispersing a drop of nanoparticle suspension on carbon films supported on copper grids. Zeiss (Ultra 55) scanning electron microscope (SEM) operated at 5 kV was used to image the morphology of the electrically printed nanoparticles-nail polish composite. The compositions of nanoparticles were carried out using X-ray fluorescence spectrometry (XRF) with a Mini X-ray tube (Amptek Inc., Beford, Mass.), operated at 40 kV, current of 100 mA and a solid state detector (Amptek Inc., Beford, Mass.). The thermal property of nanoparticles was studied using PerkinElmer differential scanning calorimetric (DSC), where 10 mg of sample was hermetically sealed in an aluminum pan and placed inside a DSC chamber under continuously purged nitrogen. A heating rate of 20° C./min from room temperature to targeted high temperatures was used for all samples.

### Example 7

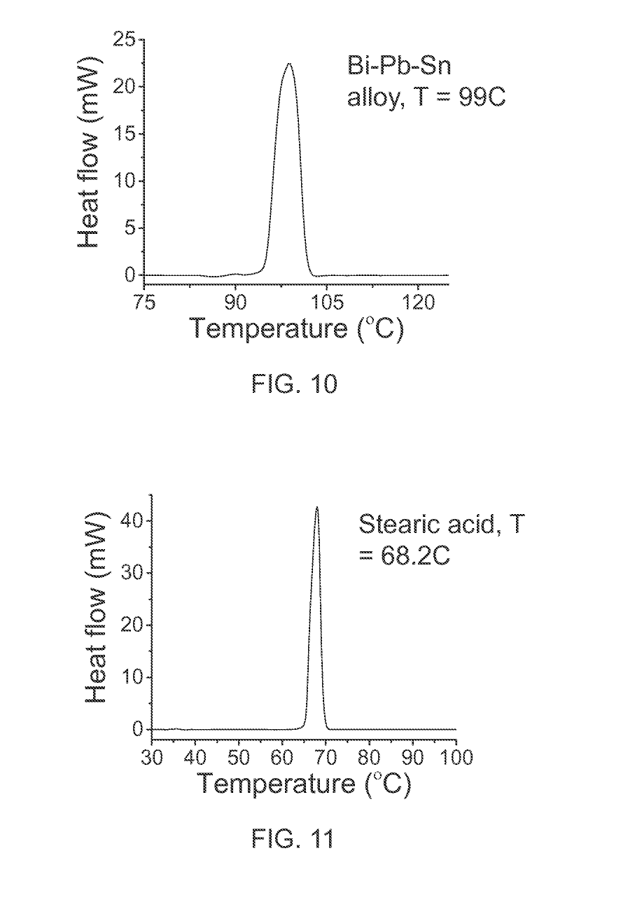

FIG. 10 illustrates a DSC curve of a piece of Bi—Pb—Sn alloy with size of ˜50 micrometer long and 30 micrometer wide without a microsphere shell that was cut from a big block of alloy.

### Example 8

FIG. 11 illustrates a DSC curve of a piece of stearic acid with size of approximately 40 micrometer long and approximately 20 micrometer wide without a shell that was cut from a centimeter scale block. Typically with the size of the phase change particles over centimeters or even at a size of 1 cm cubic or more, the application is likely for non-covert applications.

### Example 9

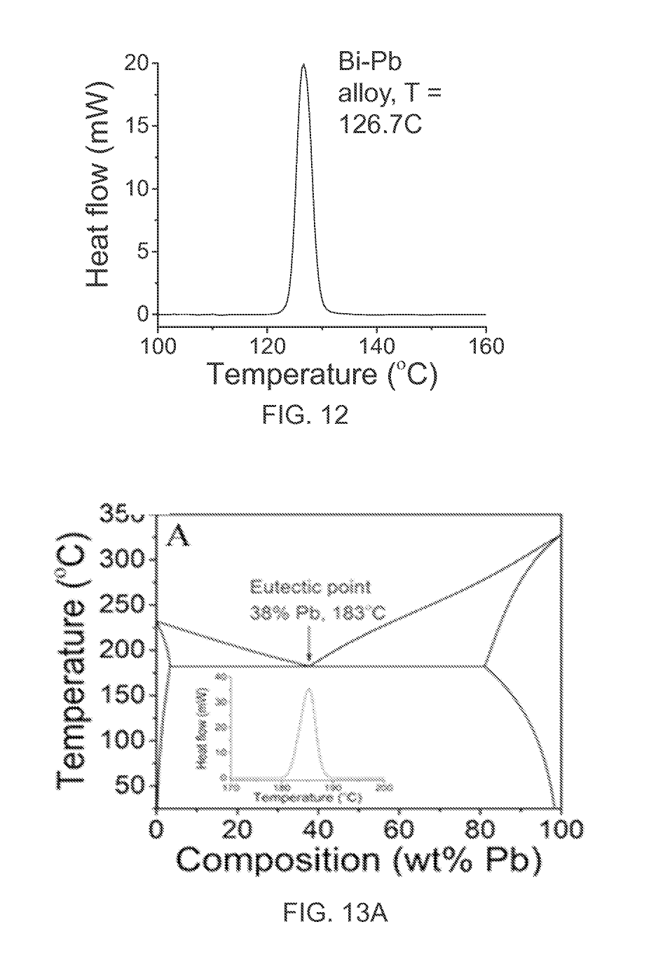

FIG. 12 illustrates a DSC curve of a piece of Bi—Pb alloy without a shell.

### Example 10

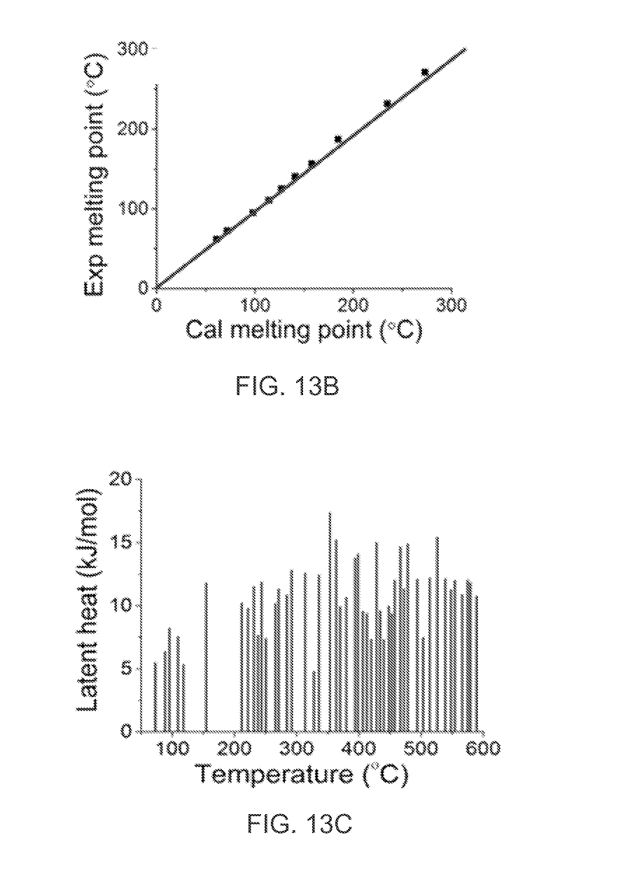

FIGS. 13A, 13B and 13C illustrate ten different metals that can form at least one binary eutectic alloys, which among any two of them have been identified, including aluminum, bismuth, cadmium, copper, gadolinium, indium, lead, magnesium, palladium and silver. According to the combination law of phase diagram, these ten different metals can form (at least) 45 types of binary alloys, 120 types of ternary eutectic alloys, 210 types of quaternary eutectic alloys, and so on. The total number of pure metals and eutectic alloys (with sharp melting peak) will be 1,023. The eutectic compositions and according melting temperatures of these alloys have been derived by using Calculation of Phase Diagram (Pandat 8.1 software), in which the total Gibbs free energy is calculated as a function of the atomic ratio of elements in a system. At given temperature, pressure and composition, Gibbs free energy will be the lowest when all phases reach thermodynamic equilibrium states. The latent heat of fusion of a eutectic alloy is calculated from the latent heats of the elements and their atomic ratio. FIG. 13A shows the calculated phase diagram of lead-tin alloy with a eutectic composition of 38% and temperature of 183° C., which are close to the measured values of 37% and 184.5° C. for lead-tin nanoparticle (FIG. 13A inset). The calculated and measured melting temperatures of ten metals and alloys are close to each other (FIG. 13B), where all data points are located on a line with slope of 45°. FIG. 13C plots the calculated melting temperatures and the latent heats of fusion of the 50 types of metals and eutectic alloys. If these nanoparticles are used to form barcodes, the total combination will be (2⁵⁰-1) or 10¹⁵. These nanoparticles have been prepared by thermally or chemically decomposing metallic precursors at stoichiometric ratio, or by simply boiling small pieces of metals or eutectic alloys inside a high boiling point solvent (poly-a-olefin or polyethylene glycol) using polyvinyl alcohol (PVA) as surfactant in nitrogen atmosphere.

### RESULTS AND DISCUSSION

Taggant Design

If there are n types of metals, where any two of them can form eutectic binary alloys, the number of possible k component alloys can be denoted as C (n, k) and derived using (i.e. Eq. 5):

$${C}_{n}^{k} = ( \begin{matrix}n \\ k\end{matrix} ) = \frac{n !}{k ! ( n - k ) !} \qquad Eq . 5$$

The possible values for k are 1, 2, 3, 4 . . . n. The total number of metals (k=1) and alloys (k=2, 3, 4 . . . n) components can be derived using (i.e. Eq. 6):

$${2}^{n} = ( \begin{matrix}n \\ 0\end{matrix} ) + ( \begin{matrix}n \\ 1\end{matrix} ) + … + ( \begin{matrix}n \\ n - 1\end{matrix} ) + ( \begin{matrix}n \\ n\end{matrix} ) \\ ( \begin{matrix}n \\ 1\end{matrix} ) + … + ( \begin{matrix}n \\ n - 1\end{matrix} ) + ( \begin{matrix}n \\ n\end{matrix} ) = {2}^{n} - 1 \qquad Eq . 6$$

10 different metals that can form binary eutectic alloys among any two of them have been found from all elements contained in the periodic table. The metals are aluminum, bismuth, cadmium, copper, gadolinium, indium, lead, magnesium, palladium, and silver. From the calculation above, the total number of metals and eutectic alloys is 2¹⁰1=1023. The large number of combinations allows labeling of hundreds different types of products.

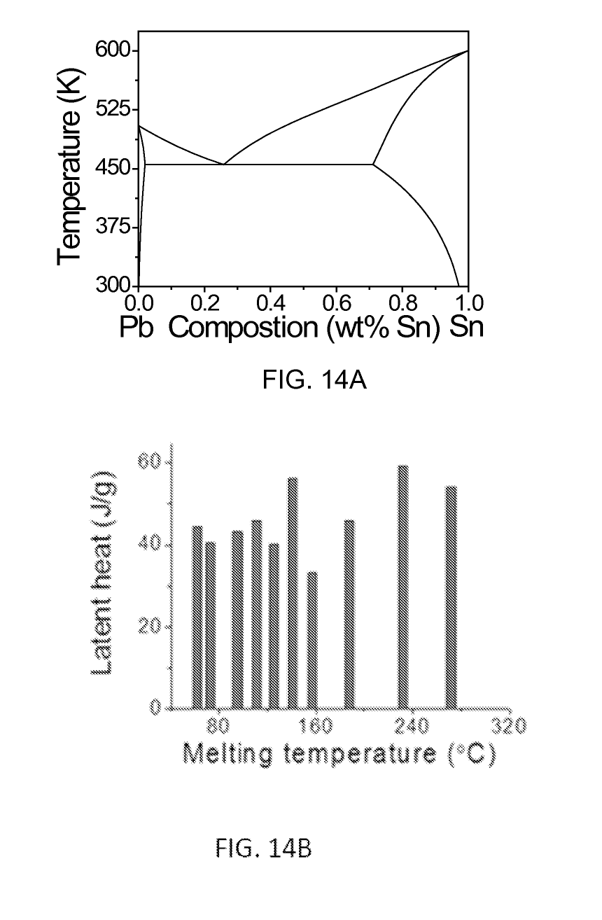

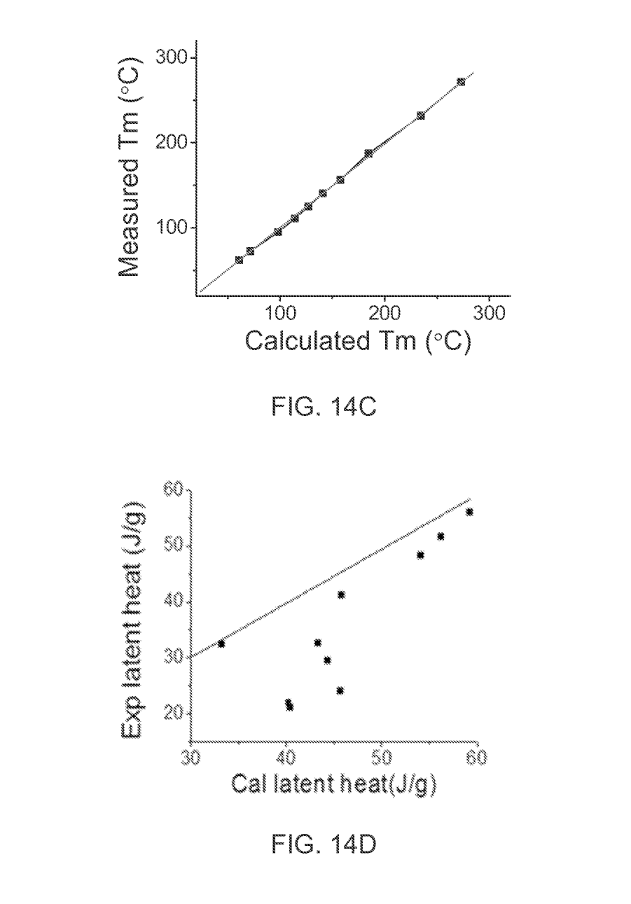

Regarding FIG. 14A and FIG. 14B, four selected elements (bismuth, indium, tin, and lead) were used to prepare nanoparticles of pure metals, binary, ternary and quartery eutectic alloys. Pandat 8.1 software was used to calculate phase diagrams, and eutectic melting temperatures of alloys. The software was built based on calculation of total Gibbs energy as function of atomic ratio of elements in a system. At any given temperature, pressure and composition, Gibbs free energy is the lowest when all phases reach thermodynamic equilibrium. The calculated lead-tin binary phase diagram is shown in FIG. 14A. The calculated eutectic molar composition, eutectic reaction and phase change temperature were used to design eutectic alloys and synthesize alloy nanoparticles. The latent heat of one eutectic alloy was calculated from the latent heat of each element and their atomic ratio. FIG. 14B shows the latent heats of fusion and the melting temperatures of eight types of metals and eutectic alloys.

Regarding FIG. 14C and FIG. 14D, DSC can accurately determine melting temperature and latent heat of metals and alloys. FIG. 14C shows the relationship between calculated and measured melting temperature of ten metals and alloys. The slope of line is close to 45° and the variation between calculated and measured melting temperatures is 1-3° C., indicating the precision of calculation and precision of composition control. Similarly, FIG. 14D shows the relation between calculated and measured latent heat of fusion of metals and alloys. The latent heats of fusion of some metals and alloys (Bi₅₈Sn₄₂, In, Sn₆₃Pb₃₇, Bi, Sn) fall close to the line with 45° slope, meaning their measured latent heats of fusion are close to the calculated values. But, some alloys (Bi_{32.5}Sn_{16.5}In₅₁, In_{66.3}Bi_{33.7}, Bi_{52.5}Pb₃₂Sn_{15.5}, In₅₂Sn₄₈, Bi_{55.5}Pb_{44.5}) have lower latent heats of fusion than calculated values. The larger deviation in latent heats of fusion may due to partial oxidization of nanoparticles in air or during thermal scanning. This was further confirmed by the fact that most of metals and alloys with lower latent heats have relatively lower melting temperatures, meaning they are more vulnerable to oxidization.

Nanoparticle Synthesis

A physical method, nanoemulsion was used to make some eutectic nanoparticles, where low melting point nanoparticles were obtained with selected solvent, temperature, and stirring rate. Alloy powders were added in high viscous solvent (poly-α-olefin or silicone oil) and heated at a temperature that is 40-60° C. higher than the melting point of alloys. Strong shear force from vigorous stirring was applied to reduce size of alloy powder. Five types of eutectic alloys such as Sn₆₃Pb₃₇, Bi_{52.5}Pb₃₂Sn_{15.5}, In₅₂Sn₄₈, Bi_{55.5}Pb_{44.5} and Bi₅₈Sn₄₂ have been made in this experiment. For example, emulsification of Sn₆₃Pb₃₇ (melting point 187° C.) was carried out by boiling 1 g of Sn₆₃Pb₃₇ powder in 40 ml poly-a-olefin (PAO) at 240° C. for 3 hours at 1400 rpm magnetic stirring. After the reaction finished, the sample was centrifuged and thoroughly washed with acetone to remove oil, and dried at 60° C. The centrifuging and washing processes were repeated three to five times to ensure the thorough removal of residual organics.

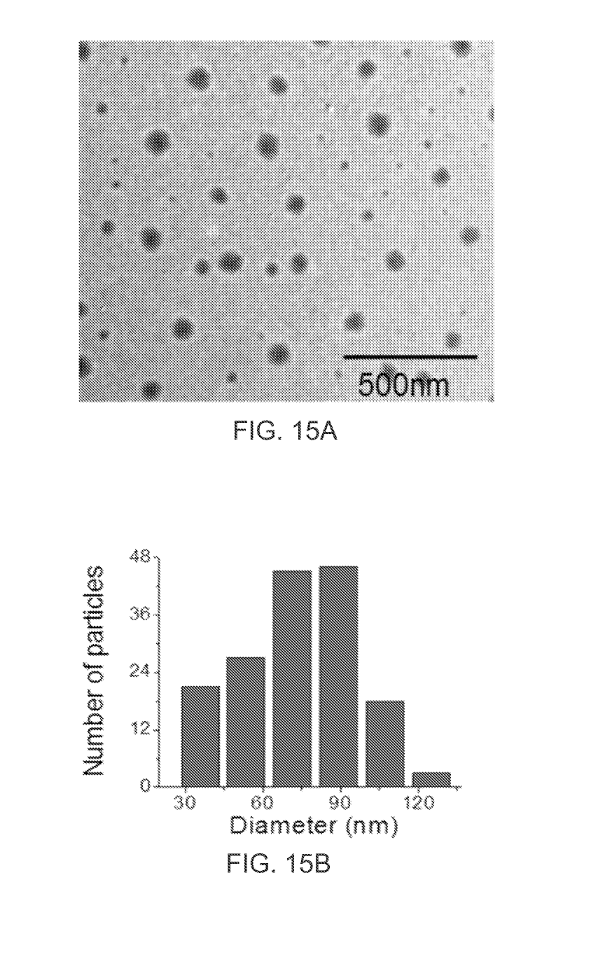

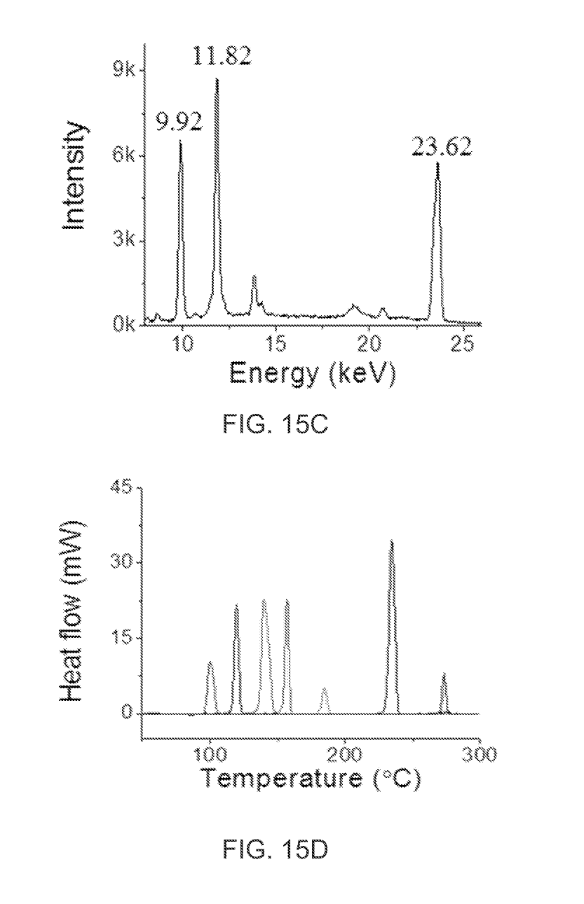

Regarding FIG. 15A to 15D, the TEM image (FIG. 15A) shows the average size of Sn₆₃Pb₃₇ eutectic alloy particles is of ˜70 nm. The nanoparticle size distribution obtained from the image was analyzed and shown in FIG. 15B. Because the diameters of most nanoparticles were larger than critical size (20 nm), their melting points were at the same as their bulk counterparts. DSC curve (FIG. 15C) of the as synthesized Pb₆₃Sn₃₇ nanoparticles shows a melting peak of 185° C., which is in good agreement with the calculated value (187° C.). XRF analysis (FIG. 15D) confirmed the presence of lead (9.90 and 11.83 keV), and tin (23.62 keV). The variation in XRF peak position may be induced by matrix effect, where the emission characteristic X-ray was absorbed by another elements.

Printing Taggant Inks

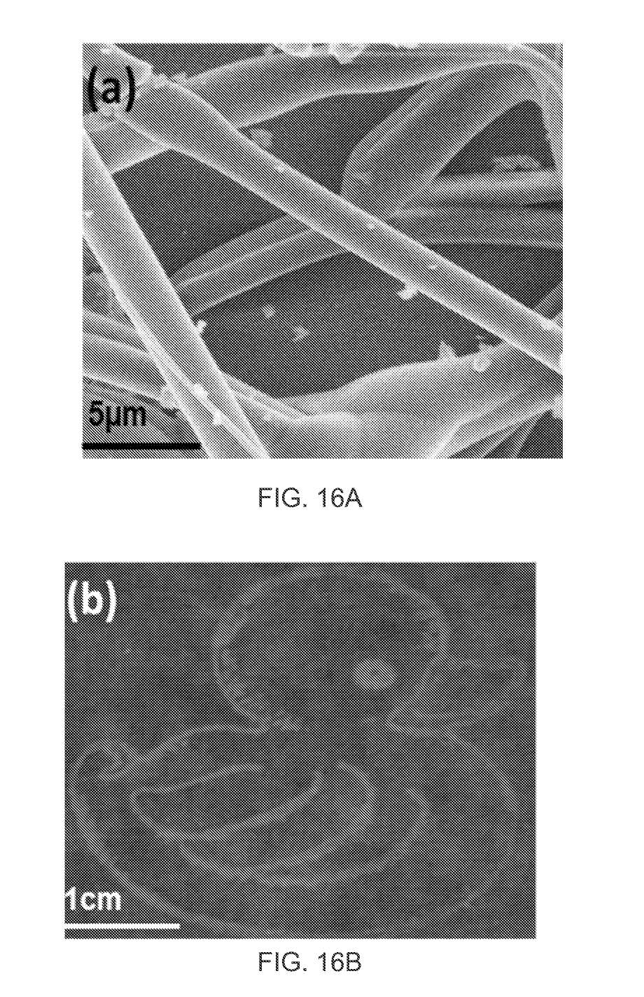

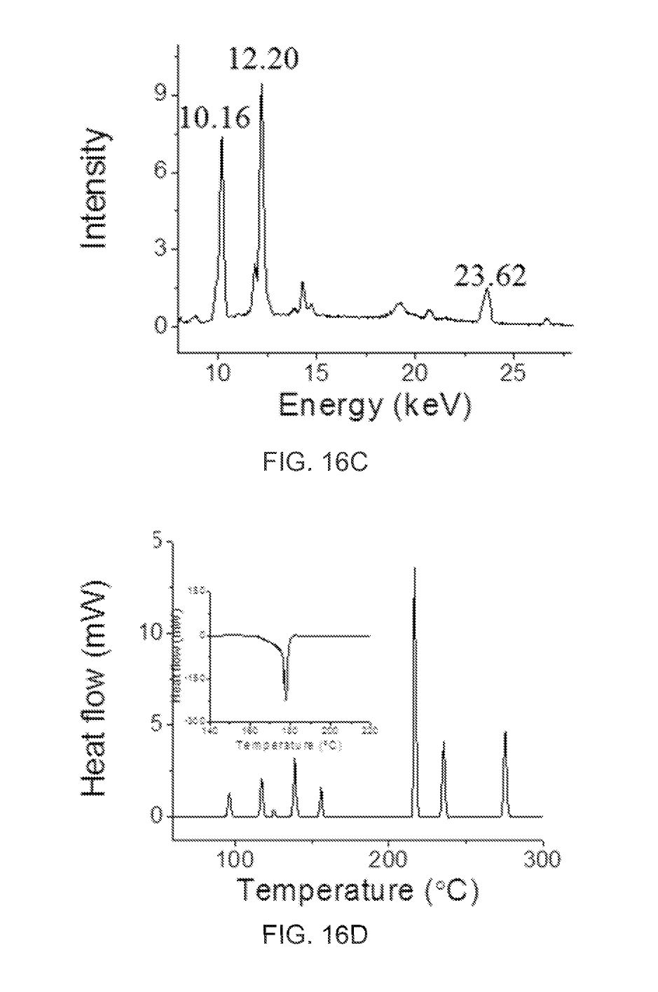

Regarding FIG. 16A, FIG. 16B and FIG. 16C, a stable suspension of nanoparticles (3-5 wt %) in PMMA (nail polish) was electrically printed on silicon substrate after adding acetone (conductive solvent). To do so, the suspension was pumped with a syringe pump, and extracted from 5 micro-fabricated nozzles at flow rate of 0.03-0.6 ml/h. The distance between nozzle and extractor was 100 μm; that between extractors was ˜100 μm; that between extractor and ground electrode was 10 mm. FIG. 16A shows an SEM image of printed PMMA composite containing 5 wt % of Bi—Sn eutectic nanoparticles, which are embedded in polymer fibers. Fluorescent image (FIG. 16B) of stamped PMMA clearly indicates the presence of rhodamine. The blue background came from paper, and the red image was from rhodamine added in stamped PMMA. The stamped pattern (FIG. 16C) contained bismuth and tin elements as shown in signature bismuth peaks at 10.16 and 12.20 keV, and signature tin peak at 23.62 keV. The small variation of energy of XRF peaks of bismuth and tin may be due to matrix effect. DSC curve shows melting peaks of 8 types of nanoparticles in PMMA matrix (FIG. 16D), where the melting peaks of nanoparticles differed in area or height because of differences in latent heat and mass fraction of nanoparticles. Note that PMMA melting is an endothermic reaction, which has a downward peak during temperature rise process (FIG. 16D inset). For clarity of metallic nanoparticle' peaks, the matrix (PMMA) peak has been removed from FIG. 16D.

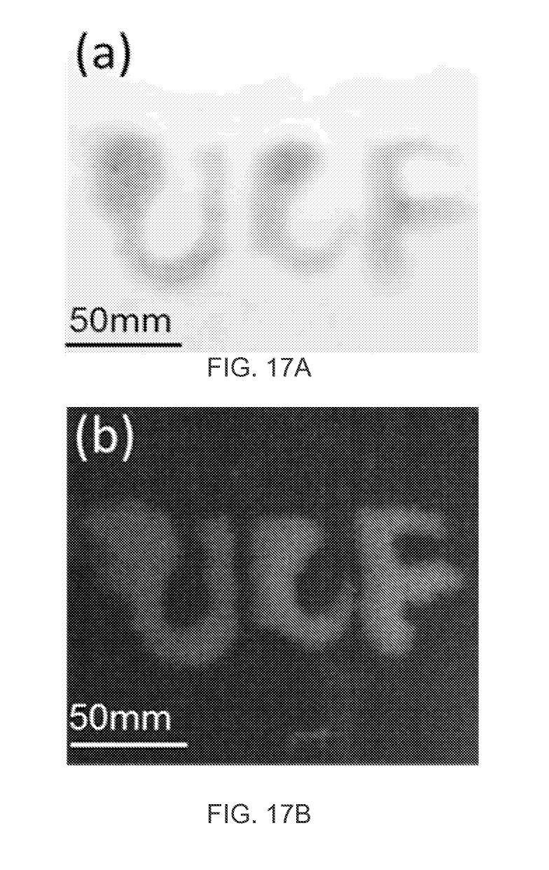

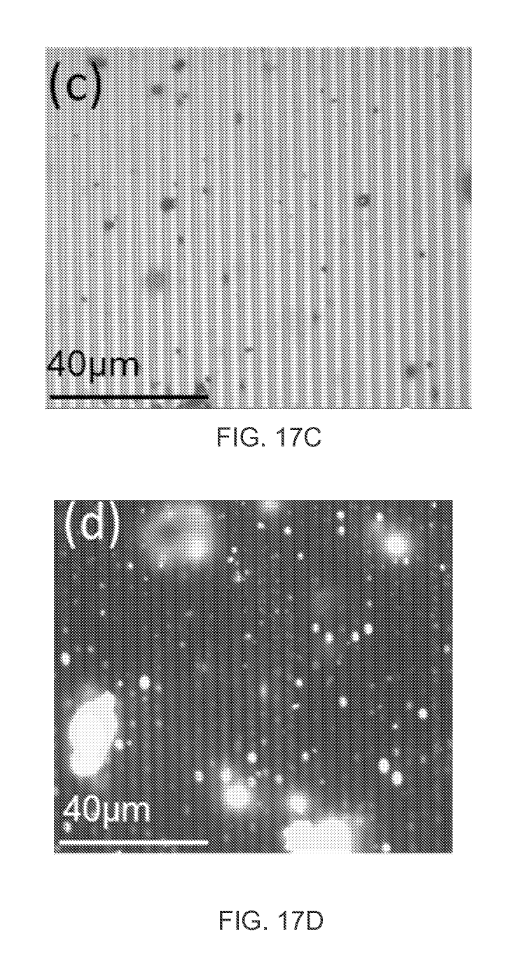

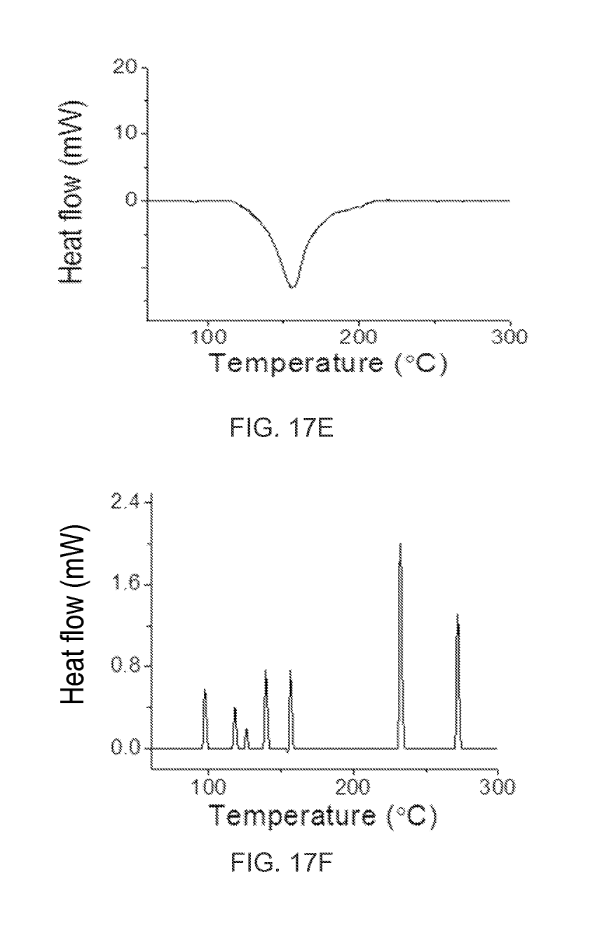

Regarding FIG. 17A to FIG. 17F, nanoparticles were added in polymer derived ceramic polyureasalizane (PUS) matrix and patterned using various methods. FIG. 17A and FIG. 17B show the optical and fluorescence images of characters written on paper using composite ink, respectively. The fluorescence signal was from rhodamine molecules in the ink. The optical and fluorescence images of micropatterns made by micro-molding method are shown in FIG. 17C and FIG. 17D, respectively. The parallel lines contain 3 wt % Bi_{55.5}Pb_{44.5} eutectic alloy nanoparticles in PUS and 1 wt % rhodamine to offer fluorescence at 480 nm excitation. FIG. 17E shows the DSC curve of PUS, where the downward peak is due to endothermic properties of PUS. FIG. 17F shows the DSC curves of PUS matrix containing 7 types of nanoparticles: Bi_{52.5}Pb₃₂Sn_{15.5} (95° C.), In₅₂Sn₄₈ (118° C.), Bi_{55.5}Pb_{44.5} (127° C.), Bi₅₈Sn₄₂ (141° C.), In (157° C.), Bi (271° C.), and Sn (236° C.). In DSC curves, PUS signal was removed. The variation in peak area or height may due to various latent heat or mass fraction of particles in the sample.

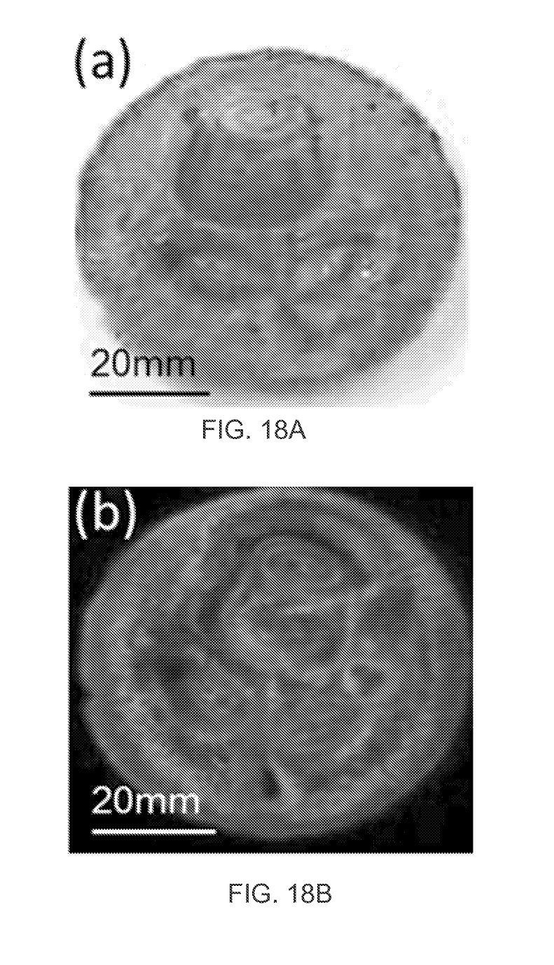

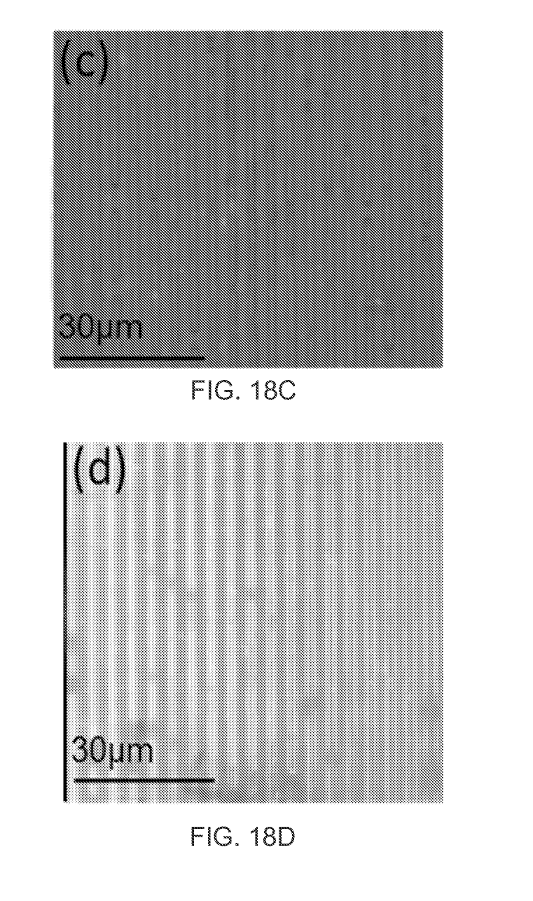

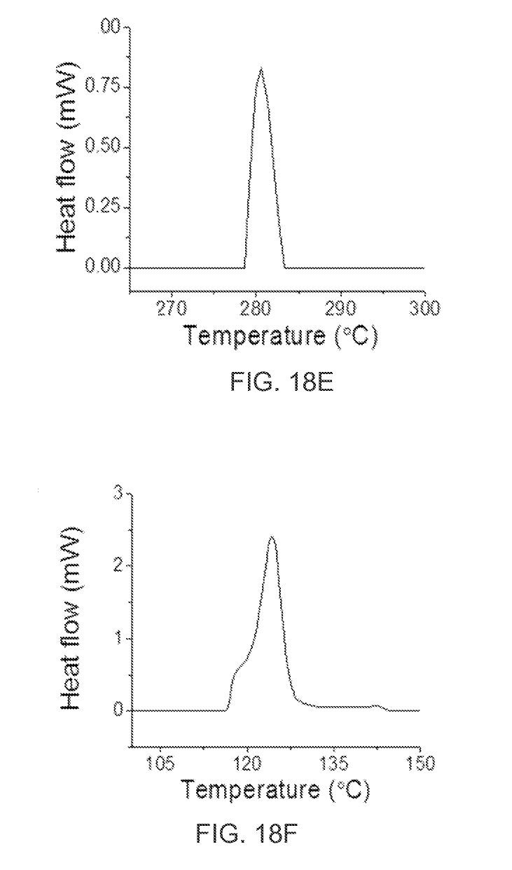

Regarding FIG. 18A to FIG. 18F, nanoparticles were also added in polyvinyl alcohol (PVA) matrix and patterned. FIG. 18A and FIG. 18B show the optical and fluorescence images of stamped 3D patterns printed from a PVA composite. The images proved that a PVA composite of nanoparticles and rhodamine dye can be easily stamped. Due to its soft nature, the patterned PVA film can be applied on solid substrates conformally. FIG. 18C and FIG. 8D are the optical and fluorescence images of PVA film molded to microscale features, suggesting PVA based nanoparticle composite can form microtaggants with high fidelity. FIG. 18E shows a DSC curve of PVA with upward peak, and FIG. 18F shows the DSC results of parallel lines contains 3 wt % of eutectic alloy nanoparticles and 1 wt % rhodamine in a PVA matrix, where the melting peak is clearly seen. In FIG. 18F, the matrix peak was removed, and the DSC curve was flattened to remove slope.

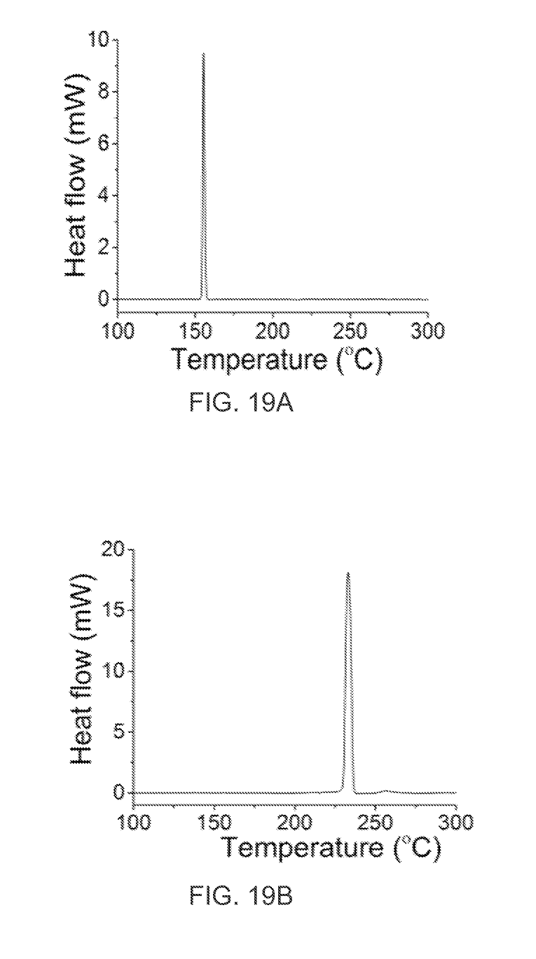

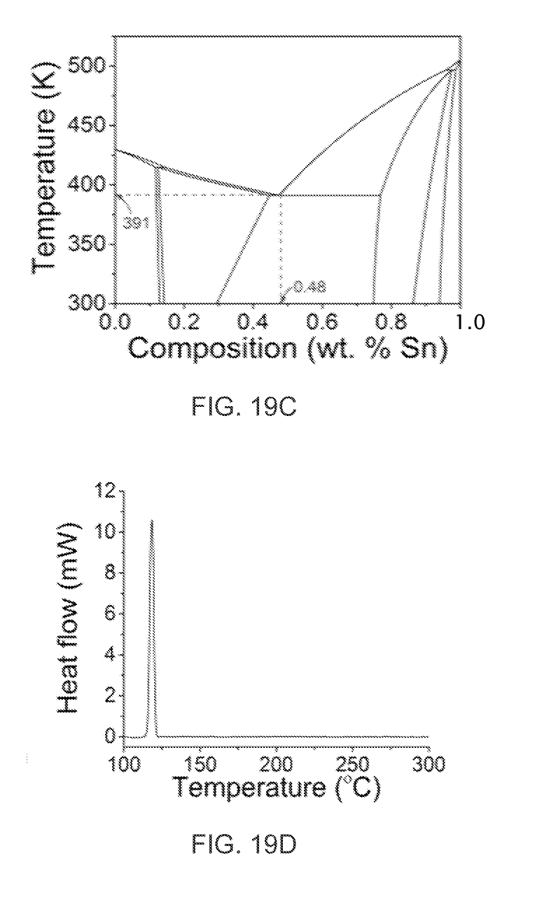

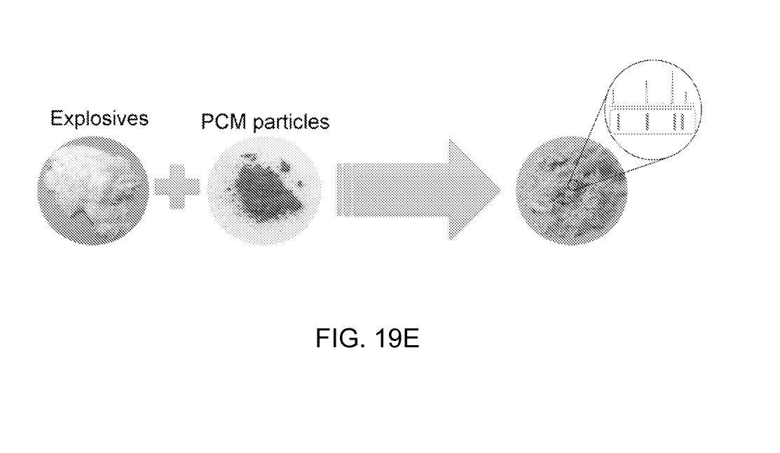

Regarding FIG. 19A to FIG. 19E, tracing explosive materials using phase change nanoparticles: In reference to FIG. 19E, in some embodiments, the taggants of the present disclosure may be incorporated into explosives to allow tracing of explosives. During explosion temperature may rise up to 1000° C. In some embodiments, materials with phase change point in the range from 100-1000° C. may be used. In addition to a number of metals in the range from 100-1000° C., generating new compounds with signature melting points is certainly possible by designing binary, ternary eutectic alloys. FIGS. 19A, 19B and 19D provide DSC scans for indium nanoparticles, tin nanoparticles, and indium-tin eutectic nanoparticles, respectively. As shown in FIG. 19C, a eutectic alloy of Indium (Tₘ=157° C.) and Tin (Tₘ=231.9° C.) has a melting temperature of 119° C. when mixing In:Sn with a ratio of 0.52:0.48. The melting point of In—Sn eutectic nanoparticles is in good agreement with the extracted value from phase diagram. To demonstrate the capability of thermal barcode, three metallic particles (indium (In), tin (Sn) and bismuth (Bi)) were synthesized and their alloy compounds (In—Sn, Sn—Bi, In—Sn—Bi) by emulsion process. Detailed synthesis procedure has been described in prior work. Briefly, emulsion of In—Sn (Tₘ=119° C.) was prepared by boiling 1 g of In_{0.52}Sn_{0.48} bulk powder in 40 ml poly-α-olefin (PAO) at 180° C. for 3 hours at 1400 rpm magnetic stirring. After the reaction completed, the emulsion was centrifuged to remove oil and thoroughly washed by acetone. This process was repeated three times to ensure complete removal of residual organics.

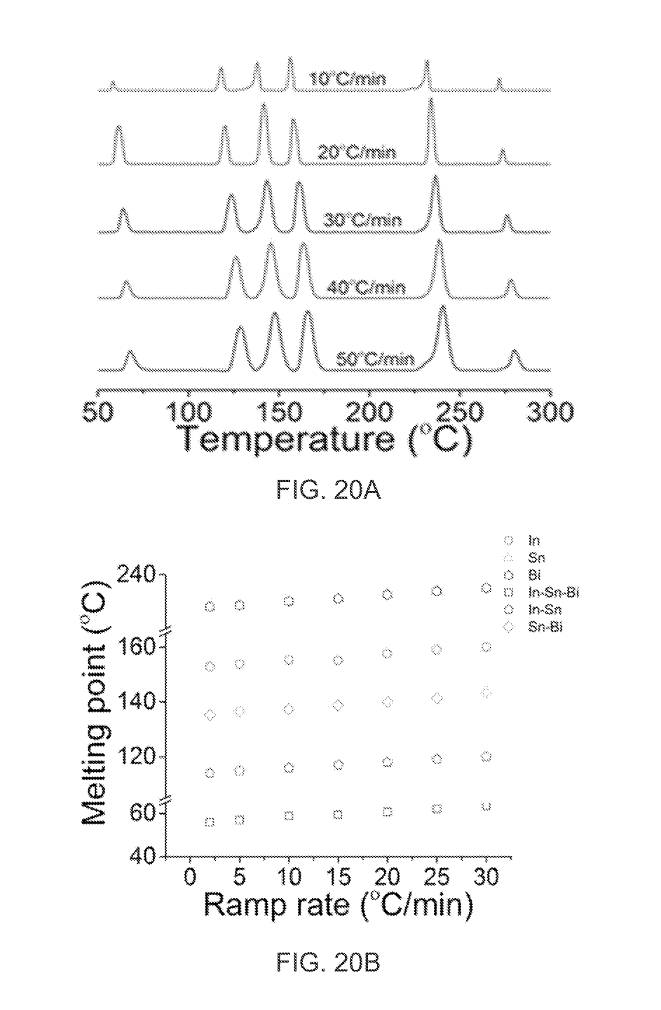

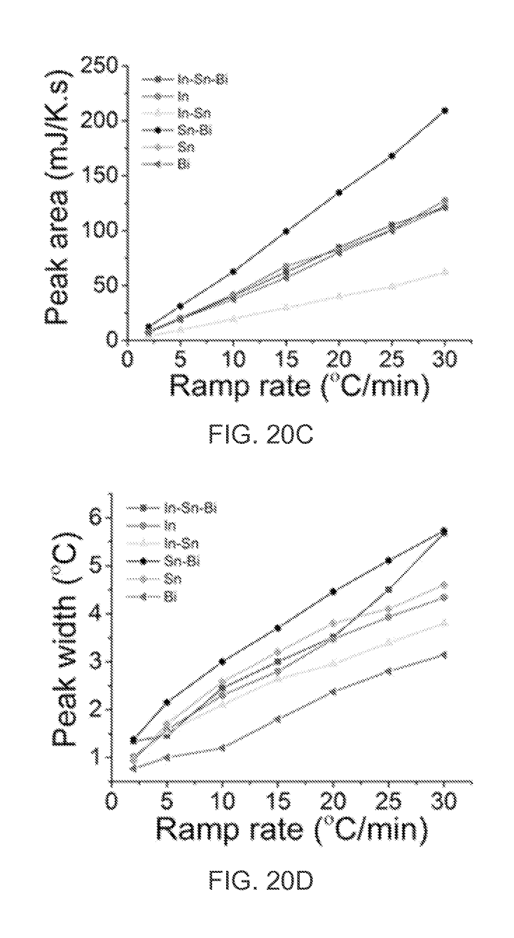

FIG. 20A to FIG. 20D, FIG. 20A illustrates five potential thermal readouts for explosives. FIG. 20B is a graph showing relation between melting point and ramp rate. FIG. 20C is graph showing relation between peak area and ramp rate. FIG. 20D is a graph showing relation between peak width and ramp rate.

A concern in utilizing any type of taggants is the risk of explosion when incorporating taggant with explosive materials. This scenario was taken into account by encapsulating the nanoparticles in SiO₂ shells of about 20 nm. It has been previously shown that encapsulating multiple particles in one single shell was possible as well. These results allow to speculate that explosive sensitization of thermal codes would probably be no more of a problem than other types of taggants. Hence, encoding process can safely be carried out by physical mixing different types of phase change nanoparticles in target explosives.

One of the key factors controlling the capacity of the thermal barcodes is the peak width, which can be derived from a modified equation (i.e. Eq. 7):

w=0.5β×Δt=0.5β×(t₁+t₂) Eq. 7

where β is the heating rate, controlled by the DSC instrument; t₁ is the times needed for the solid to melt and t₂ is the temperature to catch up with programmed temperature. For practical purpose, t₂ is defined as the time for the heat flow to fall below 1% of its maximum. Capability of tuning peak width is highly valuable because the width of typical spectral codes depends solely on intrinsic properties or amount of samples. Thermal barcodes offer same capacity as conventional binary barcodes. For instance, with 10 sharp and discrete melting peaks, it is possible to have 2¹⁰ distinctive codes, which is more than 1000 codes. As a proof of concept, a library of codes was generated from four compounds presented in this study. Information on these codes can be found in supporting information.

The detection sensitivity is governed by (1) the mass, (2) the latent heat of fusion and (3) the lowest detection limit of DSC according to the following equation (i.e. Eq. 8)

Q=m×Cₚ×β Eq. 8

in which Q is the heat flow (melting peak area), m, Cₚ and β are the mass, specific heat of phase change particles, and heat rate respectively. Utilizing equation (2) allows one to quantify the amount of taggants and explosives in one DSC run, which is not possible by other common techniques. Along with limited sample size, interference signal between explosives and taggants has become key issue in explosive detection. Methods for amplifying taggant signal during the decoding process are significantly important.

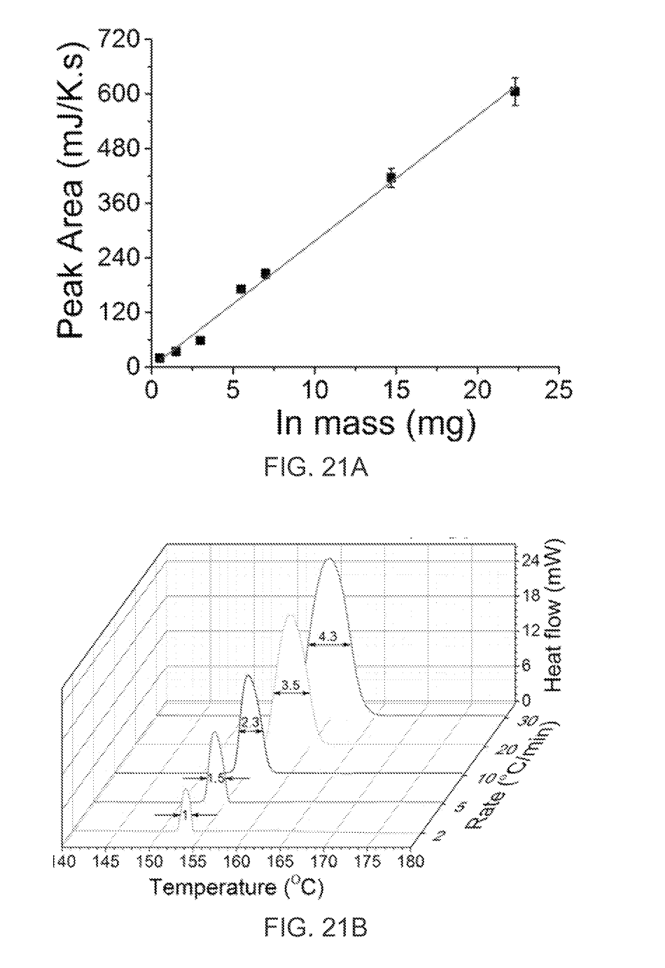

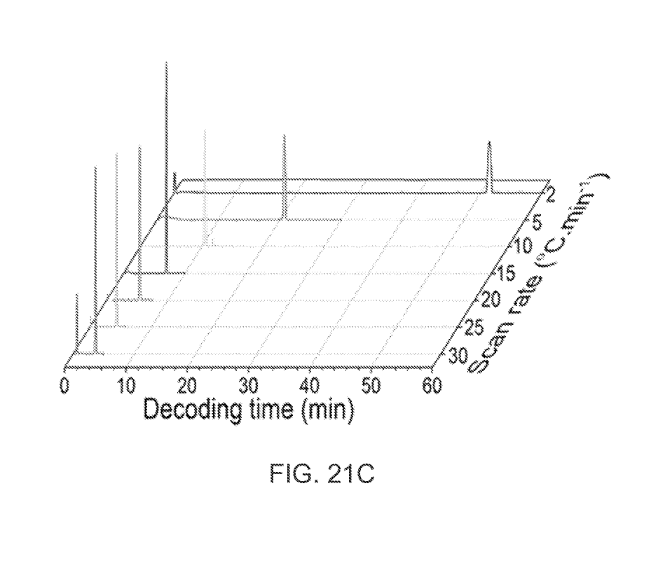

Regarding FIG. 21A to FIG. 21C, the relationship of heat flow with respect to mass of the sample was studied (FIG. 21A). Even with only 0.5 mg of In sample, the latent heat of fusion is about 20 mJ·K⁻¹·s¹. Since the minimal detectable heat flow in DSC is about 0.2 μW, which corresponds to 0.05 mg In at 2° C.·min⁻¹. To prevent interference of output signal from DNT and taggants, DNT was dissolved in ethanol and collected embedded phase change nanoparticles for decoding process. Even with a very small amount of sample, the intensity of a melting peak (aka heat flow) was amplified by simply adjusting to a higher heating rate (FIG. 21B). Since both peak width and height depends on ramp rate, decoding time will vary depending on density and distribution of melting peaks in a specific temperature range. As shown in FIG. 21C, it took less than 10 mins for a thermal run from 30° C. to 300° C. with ramp rate of 30° C./min.

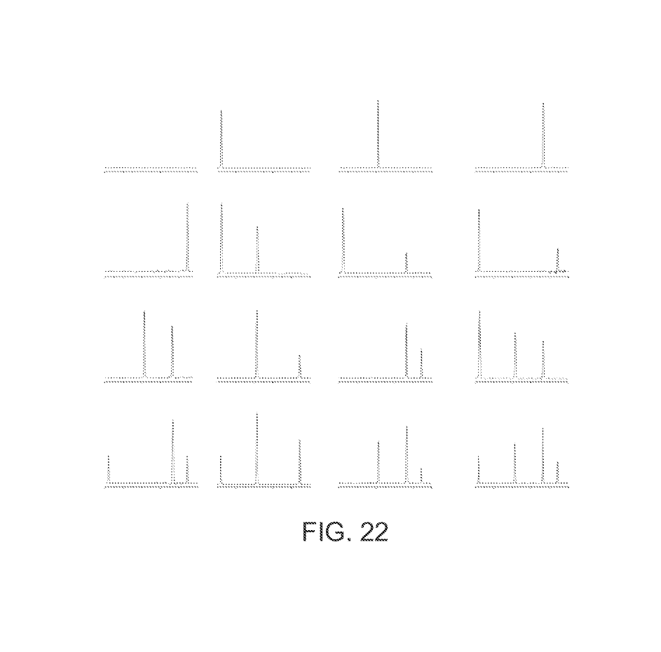

FIG. 22 presents exemplary thermal readouts.

In some embodiments, there is provided a taggant that comprises a plurality of phase change nanoparticles of one or more types having different phase change temperatures. In some embodiments, the nanoparticles can be encapsulated into a microsphere. In some embodiments, the taggants can be incorporated directly into or onto an object.

In some embodiments, there is provided a method for identifying an object comprising thermally scanning a sample of an object comprising a plurality of phase change nanoparticles of one or more types having different phase change temperatures; generating a thermal readout of the object based on the one or more types of the nanoparticles embedded in the object; and identifying the object by matching the thermal readout of the article with a thermal readout in a library of thermal readouts.

In some embodiments, there is provided a method of tagging an object comprising adding to an object a plurality of phase change nanoparticles of one or more types having different phase change temperatures.

In some embodiments, a coding system includes an object and a taggant linked to the object, the taggant comprising one or more types of phase change nanoparticles, each type of phase change nanoparticles having a predefined phase change temperature different from a phase change temperature of other types of phase change nanoparticles, wherein, when the taggant is thermally scanned, different phase change temperatures of the phase change nanoparticles result in one or more predefined melting peaks forming a code that represents information particular to the object. In some embodiments, the system further comprising: a melting peak measuring device configured for receiving a sample of the object, and reading the code particular to the sample of the object and communicating the code to a processor, the processor being programmed compare the code to a predetermined set of codes indicative of no identification or positive identification; and indicating an identification, if the code particular to the sample of the object is in the predetermined set of identifiable codes.

In some embodiments, a method for identifying an object includes thermally scanning a sample of an object including a taggant, the taggant comprising a plurality of phase change nanoparticles of one or more types having different phase change temperatures; generating a thermal readout of the sample of the object based on the one or more types of the nanoparticles of the taggant; and identifying the object by matching the thermal readout of the sample of the object with a predetermined thermal readout in a library of thermal readouts.

In some embodiments, a method of tagging an object includes linking to an object a taggant comprising a plurality of phase change nanoparticles of one or more types having different phase change melting peak temperatures.

In some embodiments, the phase change nanoparticles comprise of one or more material including metal, non-metal, metal alloy, eutectic alloy or some combination thereof. In some embodiments, the phase change nanoparticles are formed from a metal selected from a group consisting of one of aluminum, bismuth, cadmium, copper, gadolinium, indium, lead, magnesium, palladium, silver, tin, zinc, gold, nickel, antimony and combinations thereof. In some embodiments, the phase change nanoparticles comprise one or more material including organic, inorganic, a eutectic alloy, an alloy, or a combination thereof. In some embodiments, the phase change nanoparticles comprise an organic solid selected from a group consisting of one of paraffin waxes, salts, salt mixtures or some combination thereof. In some embodiments, the phase change nanoparticles comprise of one or more material from a group consisting of one of liquid crystals, proteins, organic acids, or DNAs. In some embodiments, the phase change nanoparticles have a diameter from about 20 nm to about 200 nm, about 50 nm to about 200 nm or about 20 nm to 5 cm. In some embodiments, the phase change nanoparticles are synthesized with diameter larger than the thermodynamic critical diameter of approximately 20 nm or greater. In some embodiments, the predefined melting peaks of the one or more types of phase change nanoparticle have a width of 0.5 C or less, 1.0 C or less, 0.5 C to 2 C, 5.0 C or less or 5.0 C or greater. In some embodiments, the one or more types of nanoparticle of the plurality of nanoparticles has a phase change melting time of 5 minutes or less, 10 minutes or less or greater than 5 minutes. In some embodiments, the phase change temperature of the one or more types of phase change nanoparticle are from approximately 30 C to 140 C, 30 C to 300 C, 100 C to 700 C, 60 C to 605 C or 30 C to 1000 C. In some embodiments, the types of the phase change nanoparticles are selected so a separation between the predefined melting peaks is about 0.5 or less, about 0.5 C to about 1 C, about less than 2 C or 2 C or greater. In some embodiments, the phase change nanoparticles are encapsulated into a microsphere. In some embodiments, the taggant further comprises magnetic nanoparticles, fluorescent nanoparticles, semiconductor nanoparticles or some combination thereof.

All patents, patent applications, and published references cited herein are hereby incorporated by reference in their entirety. It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. It will be appreciated that several of the above-disclosed and other features and functions, or alternatives thereof, may be desirably combined into many other different systems or applications. All such modifications and variations are intended to be included herein within the scope of this disclosure, as fall within the scope of the appended claims.

What is claimed is:

1. A coding system comprising:
an object; and
a taggant linked to the object, the taggant comprising one or more types of phase change nanoparticles, each type of phase change nanoparticles having a phase change temperature different from a phase change temperature of other types of phase change nanoparticles, wherein, when the taggant is thermally scanned, different phase change temperatures result in one or more predefined melting peaks forming a code that represents information particular to the object.

2. The system of claim 1, wherein the phase change nanoparticles comprise of one or more material including metal, non-metal, metal alloy, eutectic alloy or some combination thereof.

3. The system of claim 1, wherein the phase change nanoparticles are formed from a metal selected from a group consisting of aluminum, bismuth, cadmium, copper, gadolinium, indium, lead, magnesium, palladium, silver, tin, zinc, gold, nickel, antimony and combinations thereof.

4. The system of claim 1, wherein the phase change nanoparticles comprise one or more material including organic, inorganic, a eutectic alloy, an alloy, or a combination thereof.

5. The system of claim 1, wherein the phase change nanoparticles comprise an organic solid selected from a group consisting of one of paraffin waxes, salts, salt mixtures and combinations thereof.

6. The system of claim 1, wherein the phase change nanoparticles comprise of one or more material from a group consisting of liquid crystals, proteins, organic acids, DNAs and combinations thereof.

7. The system of claim 1, wherein the phase change nanoparticles have a diameter from about 20 nm to about 200 nm, about 50 nm to about 200 nm or about 20 nm to 5 cm.

8. The system of claim 1, wherein the phase change nanoparticles are synthesized with diameter larger than the thermodynamic critical diameter of approximately 20 nm.

9. The system of claim 1, wherein the predefined melting peaks of the one or more types of phase change nanoparticle have a width of 0.5 C or less, 1.0 C or less, 0.5 C to 2 C, 5.0 C or less or 5.0 C or greater.

10. The system of claim 1, wherein the one or more types of nanoparticle of the plurality of nanoparticles have a phase change melting time of 5 minutes or less, 10 minutes or less or greater than 5 minutes.

11. The system of claim 1, wherein the phase change temperatures of the one or more types of phase change nanoparticle are from approximately 30 C to 140 C, 30 C to 300 C, 100 C to 700 C, 60 C to 605 C or 30 C to 1000 C.

12. The system of claim 1, wherein the types of the phase change nanoparticles are selected so a separation between the predefined melting peaks is about 0.5 or less, about 0.5 C to about 1 C, about less than 2 C or 2 C or greater.

13. The system of claim 1, wherein the phase change nanoparticles are encapsulated into a microsphere.

14. The system of claim 1, wherein the taggant further comprises magnetic nanoparticles, fluorescent nanoparticles, semiconductor nanoparticles or some combination thereof.

15. The system of claim 1 further comprising: a melting peak measuring device configured for receiving a sample of the object, and reading the code particular to the sample of the object and communicating the code to a processor, the processor being programmed compare the code to a predetermined set of codes indicative of no identification or positive identification; and indicating an identification, if the code particular to the sample of the object is in the predetermined set of identifiable codes.

16. A method for identifying an object, the method comprising:
thermally scanning a sample of an object including a taggant, the taggant comprising a plurality of phase change nanoparticles of one or more types having different phase change temperatures;
generating a thermal readout of the sample of the object based on the one or more types of the nanoparticles of the taggant; and
identifying the object by matching the thermal readout of the sample of the object with a predetermined thermal readout in a library of thermal readouts.

17. The method of claim 16, wherein the phase change nanoparticles comprise one or more material including metal, non-metal, metal alloy, eutectic alloy or some combination thereof.

18. The method of claim 16, wherein the thermal readout includes one or more melting peaks indicative of the phase change temperatures of the nanoparticles.

19. The method of claim 16, wherein the one or more types of phase change material undergo a phase change from a group consisting of one of a solid-to-solid phase change, a solid-to-gas phase change and a liquid-to-gas phase change.

20. A method of tagging an object, the method comprising:
linking to an object a taggant comprising a plurality of phase change nanoparticles of one or more types having different phase change melting peak temperatures.
